(19) United States
(12) Patent Application Publication
(10) Pub. No.: US 2018/0012254 A1
(43) Pub. Date: Jan. 11, 2018

(54) ADVERTISEMENT DELIVERY APPARATUS, ADVERTISEMENT DELIVERY METHOD, AND NON-TRANSITORY COMPUTER READABLE STORAGE MEDIUM

(71) Applicant: YAHOO JAPAN CORPORATION, Tokyo (JP)

(72) Inventors: Shunsaku ASANO, Tokyo (JP); Yuki TAKI, Tokyo (JP)

(73) Assignee: YAHOO JAPAN CORPORATION, Tokyo (JP)

(21) Appl. No.: 15/639,145

(22) Filed: Jun. 30, 2017

(30) Foreign Application Priority Data
Jul. 7, 2016 (JP) 2016-135246

(51) Int. Cl. G06Q 30/02

(52) U.S. Cl. CPC G06Q 30/0255; G06Q 30/0277; G06Q 30/0269; G06Q 30/02; G06Q 30/0251; G06Q 30/0254

(57) ABSTRACT

An advertisement delivery apparatus according to the present application includes a receiving unit, a classifying unit, and a determining unit. The receiving unit receives a delivery request for a plurality of advertisements to be delivered to a terminal device. The classifying unit classifies the advertisements for which the delivery request is received by the receiving unit into a plurality of groups, based on a predetermined condition. The determining unit determines the advertisements to be delivered, for each of the groups classified by the classifying unit.

### CROSS-REFERENCE TO RELATED APPLICATION(S)

The present application claims priority to and incorporates by reference the entire contents of Japanese Patent Application No. 2016-135246 filed in Japan on Jul. 7, 2016.

### BACKGROUND OF THE INVENTION

### 1. Field of the Invention

The present invention relates to an advertisement delivery apparatus, an advertisement delivery method, and a non-transitory computer readable storage medium.

### 2. Description of the Related Art

Recently having come to be known is a method for delivering an advertisement via a predetermined advertisement delivery platform. An example of such an advertisement delivery platform is a supply-side platform (SSP) that is a platform for improving the media-side revenue. For example, an advertisement delivery apparatus in the SSP issues a bid request to a predetermined platform (such as a demand-side platform (DSP)) to acquire bids on an advertisement to be delivered, from the devices in the DSP, or acquires an advertisement from an advertisement network by requesting the advertisement from a predetermined advertisement network. The advertisement delivery apparatus in the SSP then determines the advertisement to be delivered, based on the acquired advertisement.

Such a conventional technology is, however, not quite capable of determining the advertisement to be delivered appropriately. For example, when received is a delivery request for a plurality of advertisements that are to be delivered to a terminal device, the advertisement delivery apparatus need to determine the advertisements. In such a case, the advertisement delivery apparatus is not quite capable of determining the advertisements to be delivered merely by acquiring advertisements equally from respective providers, for example.

### SUMMARY OF THE INVENTION

It is an object of the present invention to at least partially solve the problems in the conventional technology.

According to one aspect of an embodiment, an advertisement delivery apparatus includes a receiving unit that receives a delivery request for a plurality of advertisements to be delivered to a terminal device, a classifying unit that classifies the advertisements for which the delivery request is received by the receiving unit into a plurality of groups based on a predetermined condition, and a determining unit that determines the advertisements to be delivered, for each of the groups classified by the classifying unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic illustrating an example of an advertisement delivery process according to an embodiment;

FIG. 2 is a schematic illustrating an exemplary configuration of an advertisement delivery apparatus according to the embodiment;

FIG. 3 is a schematic illustrating an example of a provider information storage unit according to the embodiment;

FIG. 4 is a schematic illustrating an example of a content information storage unit according to the embodiment.

FIG. 5 is a schematic illustrating an example of an advertisement spot information storage unit according to the embodiment;

FIG. 6 is a schematic illustrating an example of a user information storage unit according to the embodiment;

FIG. 7 is a schematic illustrating an exemplary configuration of a terminal device according to the embodiment;

FIG. 8 is a flowchart illustrating an example of the advertisement delivery process according to the embodiment;

FIG. 9 is a schematic illustrating an example of how the addressee of a request is changed depending on the format in the embodiment;

FIG. 10 is a schematic illustrating an example of a classification of the advertisement spots according to the embodiment;

FIG. 11 is a schematic illustrating another example of the classification of the advertisement spots according to the embodiment;

FIG. 12 is a schematic illustrating another example of the classification of the advertisement spots according to the embodiment;

FIG. 13 is a schematic illustrating an example of how the advertisement to be delivered is determined based on a user in the embodiment;

FIG. 14 is a schematic illustrating an example of how the format is determined based on the user in the embodiment;

FIG. 15 is a schematic illustrating an example of how advertisement spots are classified based on the user in the embodiment;

FIG. 16 is a schematic illustrating an exemplary configuration of an advertisement delivery apparatus according to a modification;

FIG. 17 is a sequence chart illustrating an example of an advertisement delivery process according to the modification; and

FIG. 18 is a schematic illustrating a hardware configuration of an example of a computer implementing the functions of the advertisement delivery apparatus.

### DETAILED DESCRIPTION OF THE PREFERRED EMBODIMENTS

An advertisement delivery apparatus, an advertisement delivery method, and an advertisement delivery program according to an embodiment of the present application (hereinafter, referred to as an “embodiment”) will now be explained in detail with reference to some drawings. The embodiment is, however, not intended to limit the scope of the advertisement delivery apparatus, the advertisement delivery method, and the advertisement delivery program according to the present application in any way. In the embodiments described below, the same reference numerals are assigned to the same portions, and redundant explanations thereof are omitted herein.

### Embodiment

1. Advertisement Delivery Process

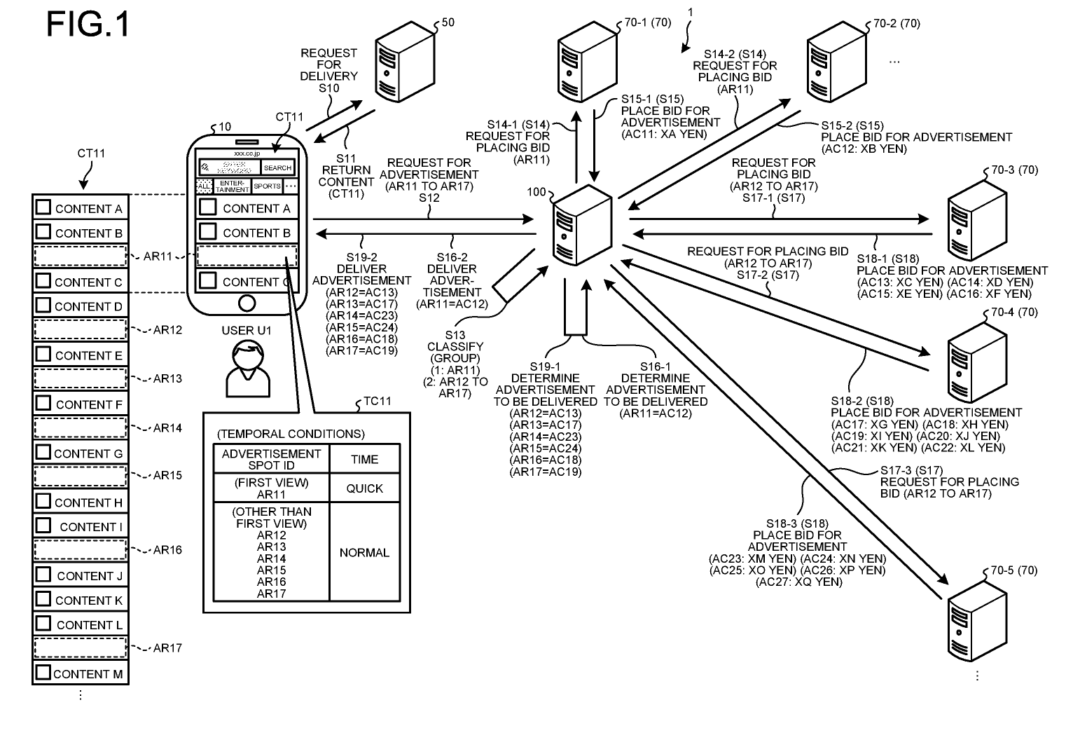

To begin with, an advertisement delivery process according to an embodiment will now be explained. FIG. 1 is a schematic illustrating an example of the advertisement delivery process according to the embodiment. An advertisement delivery apparatus 100 illustrated in FIG. 1 provides a delivery service for delivering an advertisement that is to be displayed in a piece of content delivered by a content delivery apparatus 50.

As illustrated in FIG. 1, a delivery system 1 according to the embodiment includes a terminal device 10, the content delivery apparatus 50, the advertisement delivery apparatus 100, and DSP devices 70-1 to 70-5. In the explanation hereunder, when the DSP devices 70-1 to 70-5, for example, are explained without particularly distinguishing one another, the DSP devices 70-1 to 70-5, for example, are referred to as DSP devices 70. The terminal device 10, the content delivery apparatus 50, the advertisement delivery apparatus 100, and the DSP devices 70 are communicatively connected with one another over a predetermined network. It is also possible for the delivery system 1 illustrated in FIG. 1 to include the terminal device 10 in plurality, the content delivery apparatus 50 in plurality, and the advertisement delivery apparatus 100 in plurality.

The terminal device 10 is an information processing apparatus used by a user. The terminal device 10 is implemented as a smartphone, a tablet terminal, a laptop personal computer (PC), a desktop PC, a mobile telephone, or a personal digital assistant (PDA), for example. Illustrated in FIG. 1 is an example in which the terminal device 10 is a smartphone having a touch panel function.

The terminal device 10 receives an operation performed by a user. In the example illustrated in FIG. 1, the terminal device 10 starts a predetermined browser application (hereinafter, sometimes simply referred to as a “browser”). The terminal device 10 then requests a piece of content to be displayed on the browser from the content delivery apparatus 50. If the acquired content includes an area in which an advertisement is to be displayed (hereinafter, also referred to as an “advertisement spot”), the terminal device 10 also requests the advertisement from the advertisement delivery apparatus 100. The terminal device 10 may display the content using any application for displaying the content delivered by the content delivery apparatus 50, without limitation to a browser. In the explanation hereunder, the terminal device 10 is sometimes referred to as a user. In other words, in the explanation hereunder, the term “user” can be replaced by the “terminal device 10”.

The content delivery apparatus 50 is an information processing apparatus that delivers content. In the example illustrated in FIG. 1, the content delivery apparatus 50 delivers a piece of content to be displayed on the terminal device 10, in response to a request from the terminal device 10.

Explained below is an example in which the content delivered by the content delivery apparatus 50 is a web page. In the example illustrated in FIG. 1, a piece of content, such as an article, included in a web page that is the content is sometimes referred to as partial content. In the example illustrated in FIG. 1, content A and content B, for example, correspond to the partial content. The partial content includes, for example, character information, and an image that is related to the article represented by the character information. The partial content may be any content. For example, the partial content may consist only of character information, consist of only images, or may be video information.

The advertisement delivery apparatus 100 provides an advertisement delivery service for delivering an advertisement in response to an advertisement delivery request (hereinafter, also referred to as an “advertisement request”). For example, the advertisement delivery apparatus 100 is an advertisement delivery apparatus in an SSP. For example, the advertisement delivery apparatus 100 requests the DSP devices 70 to bid on advertisements, which will be the candidates for the advertisement to be delivered, in response to an advertisement request from the terminal device 10. For example, when the advertisement delivery apparatus 100 receives an advertisement request for a plurality of advertisement spots, the advertisement delivery apparatus 100 acquires advertisements for each of the advertisement spots, and determines the advertisement to be delivered (hereinafter, also referred to as an “advertisement to be delivered”). For example, the advertisement delivery apparatus 100 classifies a plurality of advertisements for which a delivery request is received into a plurality of groups based on a predetermined condition, and determines the advertisement to be delivered for each of the classified groups.

The DSP device 70 is a device that places a bid on an advertisement, in response to a request from the advertisement delivery apparatus 100. An example of the DSP device 70 includes an advertisement providing server serving as an advertisement provider. The DSP device 70 herein is a device that places a bid on an advertisement in response to a bid request received from the advertisement delivery apparatus 100. In other words, the DSP device 70 places a bid on an advertisement by designating a bidding price, in response to a bid request from the advertisement delivery apparatus 100. The advertisement delivery apparatus 100 can determine any desirable one of the advertisements on which bids are placed by the DSP devices 70, as the advertisement to be delivered.

Depending on the platforms (DSP) of the DSP devices 70, the number of advertisements for which a bid request can be accepted, the time required to place a bid after the bid request is received from the advertisement delivery apparatus 100, and the formats for which the placement of a bid is permitted may be different among the DSP devices 70. The advertisement format herein means a format of advertisement data, such as “characters only”, “images only”, “a combination of images and characters”, or “video”. Listed herein are merely some examples, and the advertisement format may include any data format. For example, some DSP devices 70 may be permitted to receive a bid request for five advertisements, and the other DSP devices 70 may be permitted to receive a bid request for one advertisement. Furthermore, for example, some DSP devices 70 may require 50 msec. (“microseconds”; the same applies below) or so to place a bid after the bid request is received, and the other DSP devices 70 may require 100 msec. or so to place a bid after the bid request is received. Furthermore, for example, some DSP devices 70 may be permitted to place their bids on advertisements with a format combining images and characters, and the other DSP devices 70 may be permitted to place their bids on advertisements in any format other than video. These points will be described later in detail.

An example of an advertisement delivery process will now be explained with reference to FIG. 1. Explained in FIG. 1 is an example in which the user is the user identified by the user ID “U1” (hereinafter, sometimes referred to as a “user U1”).

As illustrated in FIG. 1, the terminal device 10 transmits a content delivery request to the content delivery apparatus 50 (Step S10). For example, the terminal device 10 transmits a content delivery request to the content delivery apparatus 50, in response to an operation performed by the user U1.

The content delivery apparatus 50 having received the delivery request from the terminal device 10 delivers the content to the terminal device 10 (Step S11). In the example illustrated in FIG. 1, the content delivery apparatus 50 delivers content CT11 to the terminal device 10. Specifically, the content delivery apparatus 50 delivers the content CT11 in which pieces of content, such as pieces of content A to M, and advertisement spots, such as advertisement spots AR11 to AR17, are arranged along a vertical direction to the terminal device 10. In the explanation hereunder, when the advertisement spots AR11 to AR17, for example, are explained without particularly distinguishing one another, the advertisement spots AR11 to AR17 are referred to as advertisement spots AR. The number and the positions of the advertisement spots AR included in the content may vary depending on the information related to the user who uses the terminal device 10, the specific content, or the user to whom the content is transmitted. For example, the number and the positions of the advertisement spots AR included in the content CT11 to be delivered to the terminal device 10 of the user U1 may be different from those included in the content CT11 that is to be delivered to the terminal device 10 of a user U3 (see FIG. 6). For example, when the user U1 exhibits a higher advertisement click-through rate compared with the user U3, the content CT11 including a larger number of advertisement spots AR may be delivered to the terminal device 10 of the user U1, than that delivered to the terminal device 10 of the user U3.

In the example illustrated in FIG. 1, an “all” column is selected on the terminal device 10. In other words, in the example illustrated in FIG. 1, the content CT11 including pieces of partial content corresponding to the “all” column is delivered. The other columns, such as “entertainment” or “sports” in FIG. 1 will be described later.

As mentioned earlier, in the example illustrated in FIG. 1, delivered to the terminal device 10 is the content CT11 in which the pieces of content, such as the pieces of content A to M, and the advertisement spots, such as the advertisement spots AR11 to AR17, are arranged along one direction (hereinafter, referred to as a “vertical direction”). As illustrated in FIG. 1, the partial content and the advertisement spots AR are arranged in the order of the content A, the content B, the advertisement spot AR11, the content C, the content D, and the advertisement spot AR12 . . . in the content CT11. In other words, the advertisement spots AR in the content CT11 are arranged at their predetermined displayed positions. For example, the advertisement spot AR11 is positioned at a third displayed position from the top, and the advertisement spot AR13 is positioned at an eighth displayed position from the top. In other words, each of the advertisement spots AR corresponds to a displayed position. In the explanation hereunder, the term “advertisement spot AR” can be replaced with the term “displayed position”.

On the terminal device 10, the pieces of partial content included in the content and the advertisement spots are displayed as a list in which the content and the advertisement spots are arranged along a predetermined direction. For example, at the timing at which the content CT11 is delivered to the terminal device 10, some of the partial content included in the content CT11 and the advertisement spots positioned in the upper portion are displayed as a list. Specifically, in the example illustrated in FIG. 1, among the pieces of content included in the content CT11, the content A, the content B, the advertisement spot AR11, and the content C are displayed as a list on the terminal device 10, in the order listed herein in a manner arranged along the vertical direction. In the manner described above, the part of the content CT11 displayed on the terminal device 10 at the timing at which the content CT11 is delivered is sometimes referred to as a “first view”. In the explanation hereunder, a first part of the content CT11 to be displayed on the terminal device 10 is sometimes referred to as the first view, but the first view is not limited to the part displayed on the terminal device 10 at the timing at which the content CT11 is delivered, but may also include the content D that is positioned immediately below, for example.

The content A, the content B, the advertisement spot AR11, and the content C displayed on the terminal device 10 make up a part of the content CT11, and the user U1 can display the remaining portion that follows this part, by performing a predetermined user operation. For example, the user U1 can display the following content D, advertisement spot AR12, content E, and the like, by making a user operation of moving his/her finger kept in contact with the display screen of the terminal device 10, from the bottom to the top thereof, and scrolling down the window.

Because the content CT11 received at Step S11 includes seven advertisement spots AR11 to AR17, the terminal device 10 transmits an advertisement request for the advertisements to be displayed in the advertisement spots AR11 to AR17, respectively, included in the received content CT11, to the advertisement delivery apparatus 100 (Step S12). The terminal device 10 may also request the advertisements to be displayed in some of the advertisement spots AR11 to AR17 (e.g., the advertisement spots AR11 to AR13 positioned in the upper part of the content CT11), but it is assumed herein that, to simplify the explanation, the terminal device 10 requests the advertisements to be displayed in the seven advertisement spots AR11 to AR17.

Among the seven advertisement spots AR11 to AR17, it is preferable for the advertisement to be displayed in the advertisement spot AR11, which is included in the first view, to be delivered as quickly as possible. To address this issue, in the example illustrated in FIG. 1, a time-related condition for the advertisement to be displayed in the advertisement spot AR11 that is included in the first view is specified as “quick”, as indicated in temporal conditions TC11, and the time-related condition for the advertisements to be displayed in the advertisement spots AR12 to AR17 is specified as “normal”. In the example illustrated in FIG. 1, it is assumed that the advertisement delivery apparatus 100 has acquired the information related to the temporal conditions TC11 in advance. For example, the terminal device 10 may transmit the information related to the temporal conditions TC11 at the same timing as the advertisement request is transmitted to the advertisement delivery apparatus 100 at Step S12.

The advertisement delivery apparatus 100 having acquired the advertisement request from the terminal device 10 classifies the advertisement spots AR corresponding to the advertisement request into a plurality of groups based on a predetermined condition (Step S13). For example, the advertisement delivery apparatus 100 classifies the advertisement spots AR corresponding to the advertisement request into a plurality of groups based on the temporal conditions TC11. The group herein means a group of advertisement spots that are commonly processed, in the process of determining the advertisements to be delivered to the advertisement spots AR. The advertisement delivery apparatus 100 may also acquire the advertisement request from the content delivery apparatus 50.

In the example illustrated in FIG. 1, the advertisement delivery apparatus 100 classifies the seven advertisement spots AR11 to AR17 into two groups, one of which includes the advertisement spot AR specified with the time-related condition “quick”, and the other group including the advertisement spots AR specified with the time-related condition “normal”. For example, the advertisement delivery apparatus 100 classifies the seven advertisement spots AR11 to AR17 into two groups, one of which including the advertisement spot AR included in the first view, and the other group including the other advertisement spots AR. In other words, the advertisement delivery apparatus 100 classifies the advertisement spots AR11 to AR17 into two groups, one of which includes the advertisement spot AR11 included in the first view (hereinafter, also referred to as a “first group”), and the other group including the other advertisement spots AR12 to AR17 (hereinafter, also referred to as a “second group”). The advertisement delivery apparatus 100 then determines the advertisements to be delivered to the advertisement spots AR through a different bidding process (hereinafter, also referred to as an “auction”) for each of the first group and the second group.

To begin with, the advertisement delivery apparatus 100 requests the DSP devices 70 to place their bids on their advertisements that will be the candidates for the advertisement to be delivered to the advertisement spot AR included in the first group (advertisement spot AR11) (Step S14). For example, the advertisement delivery apparatus 100 requests the DSP devices 70 satisfying a predetermined condition to place their bids on their advertisements that will be the candidates for the advertisement to be delivered to the advertisement spot AR11. For example, the advertisement delivery apparatus 100 may send a request for placing a bid on an advertisement that will be a candidate for the advertisement to be delivered to the advertisement spot AR11 to a DSP device 70 having an advertisement evaluation (e.g., an expected revenue) equal to or higher than a predetermined threshold assuming that the advertisement provided by the DSP device 70 is delivered as the advertisement to be delivered to the advertisement spot AR included in the first view. The advertisement delivery apparatus 100 may also send a bid request for an advertisement that will be a candidate for the advertisement to be delivered to the advertisement spot AR11 to a DSP device 70 that requires less time (waiting time) in placing a bid after the bid request is received.

Furthermore, for example, the advertisement delivery apparatus 100 may also send a bid request for an advertisement that will be a candidate for the advertisement to be delivered to the advertisement spot AR11 to a DSP device 70 having a record of successful bids for the first view satisfying a predetermined reference. In FIG. 1, it is assumed that there are two DSP devices 70, the DSP device 70-1 and the DSP device 70-2 having an advertisement achieving an expected revenue equal to or higher than a predetermined threshold, assuming that the advertisements are delivered as the advertisement to be delivered for the first view. In the explanation hereunder, an advertisement on which a bid is placed by the DSP device 70 is sometimes referred to as a “bid advertisement”. For example, the bid advertisement of the DSP device 70 may be any advertisement for which a payment is accrued based on any one of various types of methods, e.g., an advertisement for which a payment is accrued at the timing the bid advertisement is delivered as the advertisement to be delivered and clicked by a user (hereinafter, referred to as a “pay-per-click advertisement”), or an advertisement for which a payment is accrued when the bid advertisement is delivered as the advertisement to be delivered and displayed on the terminal device 10 (hereinafter, referred to as an “pay-per-impression advertisement”). To simplify the explanation, in the explanation hereunder, it is assumed that, unless specified otherwise, the bid advertisement is a pay-per-click advertisement.

In the example illustrated in FIG. 1, for the advertisement spot AR11 included in the first group, the advertisement delivery apparatus 100 requests the DSP device 70-1 to place a bid on the advertisement (Step S14-1), and requests the DSP device 70-2 to place a bid on the advertisement (Step S14-2).

The DSP device 70 having received the bid request at Step S14 then places a bid on the advertisement to the advertisement delivery apparatus 100 (Step S15). Specifically, the DSP device 70-1 places a bid on an advertisement AC11 at a bidding price of XA yen to the advertisement delivery apparatus 100 (Step S15-1), and the DSP device 70-2 places a bid on an advertisement AC12 at a bidding price of XB yen to the advertisement delivery apparatus 100 (Step S15-2). The DSP device 70 responding to the bid request from the advertisement delivery apparatus 100 may transmit the bid advertisement itself, or any information related to the bid advertisement such as information for identifying the bid advertisement or information related to the bidding price.

The advertisement delivery apparatus 100 then determines the advertisement to be delivered to the advertisement spot AR which belongs to the first group (Step S16-1). Specifically, the advertisement delivery apparatus 100 determines the advertisement to be delivered to the advertisement spot AR11 specified with the time-related condition “quick”. Used in FIG. 1 is an example in which the advertisement delivery apparatus 100 uses effective cost per mille (eCPM) as the evaluation (expected revenue) of an advertisement. The evaluation related to the advertisement may also a click-through rate (CTR), cost per click (CPC), or a conversion rate (CVR), for example, without limitation to eCPM.

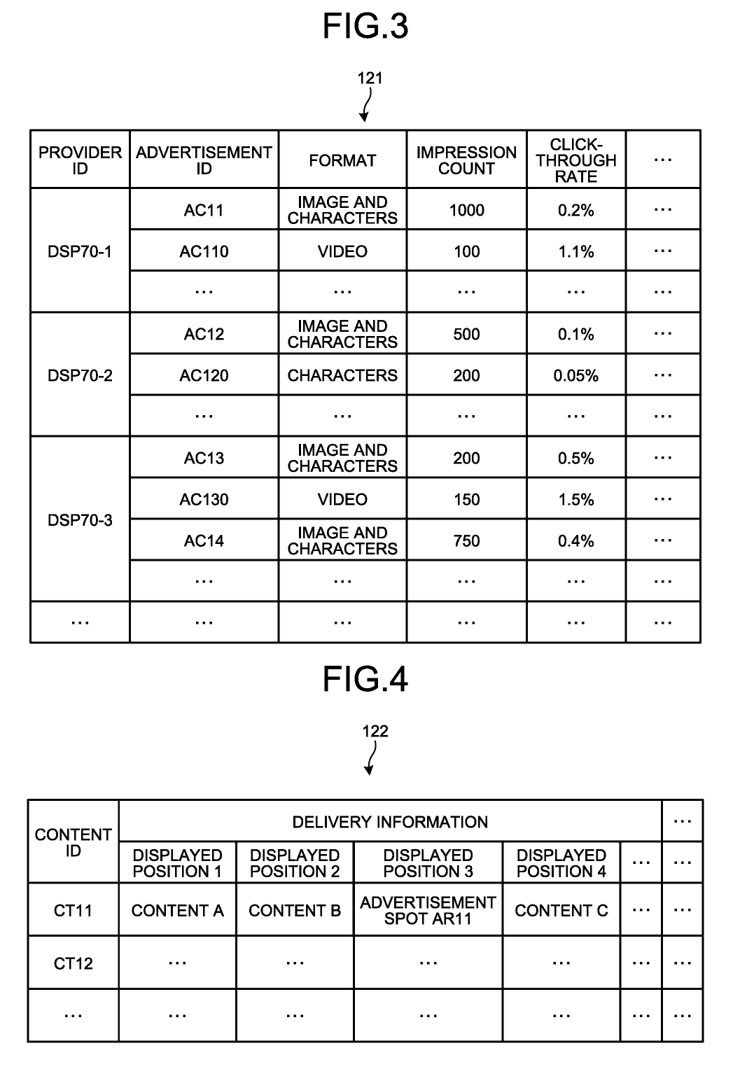

For example, the advertisement delivery apparatus 100 may calculate eCPM that is the expected revenue based on the bidding price of the bid advertisement, or based on the record of successful bids stored in a provider information storage unit 121 (see FIG. 3), for example, and determine the advertisement to be delivered to each of the advertisement spots AR based on the scale of the calculated eCPM. With such a calculation, even when the bid advertisements include pay-per-click advertisements and pay-per-impression advertisements, the advertisement delivery apparatus 100 can determine the advertisement to be delivered to each of the advertisement spots AR based on the calculated eCPM.

For example, the advertisement delivery apparatus 100 may determine the advertisement to be delivered to advertisement spot AR11 which belongs to the first group by comparing the expected revenue of the advertisement AC11 with the expected revenue of the advertisement AC12. As illustrated in FIG. 1, if the expected revenue that is based on the bidding price or the click-through rate, for example, of the advertisement AC12 is higher than the expected revenue that is based on the bidding price or the click-through rate, for example, of the advertisement AC11, the advertisement delivery apparatus 100 may determine the advertisement AC12 as the advertisement to be delivered to the advertisement spot AR11.

The advertisement delivery apparatus 100 having determined the advertisement to be delivered to the advertisement spot AR11 at Step S16-1 delivers the advertisement AC12, which is the advertisement to be delivered to the advertisement spot AR11, to the terminal device 10 (Step S16-2). For example, the advertisement AC12 is displayed in the advertisement spot AR11 on the terminal device 10 illustrated in FIG. 1. In the manner described above, the advertisement delivery apparatus 100 determines the advertisement to be delivered to the advertisement spot AR11 specified with the time-related condition “quick”, before determining the advertisements to be delivered to the other advertisement spots AR. In this manner, the advertisement delivery apparatus 100 can display the advertisement in the advertisement spot AR11 included in the first view at an appropriate timing by delivering the advertisement to be delivered to the advertisement spot AR11 that is specified with the time-related condition “quick” more quickly than the other advertisements to be delivered.

The advertisement delivery apparatus 100 then requests the DSP devices 70 to place their bids on their advertisements that will be the candidates for the advertisements to be delivered for the advertisement spots AR belonging to the second group (advertisement spots AR12 to AR17) (Step S17). For example, the advertisement delivery apparatus 100 requests the DSP devices 70 satisfying a predetermined condition to place their bids on their advertisements that will be the candidates for the advertisements to be delivered to the advertisement spots AR12 to AR17. For example, the advertisement delivery apparatus 100 may send a bid request for advertisements that will be the candidates for the advertisements to be delivered to the advertisement spots AR12 to AR17 to a DSP device 70 that is permitted to receive a bid request for advertisements in a number equal to or greater than a predetermined threshold at once. The advertisement delivery apparatus 100 may perform the process at S17 in parallel with the process at Steps S16-1 to S16-2.

In FIG. 1, the advertisement delivery apparatus 100 may send a bid request for the advertisements that will be the candidates for the advertisements to be delivered to the advertisement spots AR12 to AR17 to a DSP device 70 that is permitted to receive a bid request for two or more advertisements at once. In FIG. 1, it is assumed that there are three DSP devices 70, the DSP devices 70-3 to 70-5, that are permitted to receive a bid request for two or more advertisements at once. Specifically, it is assumed that the DSP device 70-3 is permitted to receive a bid request for four advertisements at once, that the DSP device 70-4 is permitted to receive a bid request for six advertisements at once, and that the DSP device 70-5 is permitted to receive a bid request for five advertisements at once.

For example, the advertisement delivery apparatus 100 may determine the DSP device 70 to which the bid request is addressed by referring to the permitted number of bids (not illustrated), permitted to each of the DSP devices 70, stored in the provider information storage unit 121 (see FIG. 3). Furthermore, for example, if a bid request for an advertisement is to be sent only to the DSP device 70 permitted to receive a bid request for advertisements in a number greater than the number of advertisement spots AR included in the second group, the advertisement delivery apparatus 100 does not need to request the DSP device 70-3 and the DSP device 70-5 to place their bids on their advertisements. In such a case, the advertisement delivery apparatus 100 may send a bid request for the advertisements to the DSP device 70-4, or to any other DSP devices 70 permitted to receive a request for bids on six or more advertisements at once. Alternatively, the advertisement delivery apparatus 100 may send a bid request for an advertisement only to the DSP devices 70 having a record of successful advertisement bids (e.g., a successful bid count) satisfying a predetermined reference. For example, if the successful bid count of the DSP device 70-5 does not satisfy a predetermined threshold (e.g., “1000 times”), the advertisement delivery apparatus 100 may omit sending a request for placing a bid on the advertisement to the DSP device 70-5.

In the example illustrated in FIG. 1, for the advertisement spots AR12 to AR17 included in the second group, the advertisement delivery apparatus 100 requests the DSP device 70-3 to place a bid on the advertisement (Step S17-1), requests the DSP device 70-4 to place a bid on the advertisement (Step S17-2), and requests the DSP device 70-5 to place a bid on the advertisement (Step S17-3).

The DSP devices 70 having received the bid request at Step S17 then place their bids on the advertisements to the advertisement delivery apparatus 100 (Step S18). For example, the DSP device 70-3 places bids on the four advertisements AC13 to AC16 to the advertisement delivery apparatus 100 (Step S18-1). Specifically, the DSP device 70-3 places a bid on the advertisement AC13 at a bidding price XC yen, a bid on the advertisement AC14 at a bidding price XD yen, a bid on the advertisement AC15 at a bidding price XE yen, and a bid on the advertisement AC16 at a bidding price XF yen, to the advertisement delivery apparatus 100.

Furthermore, for example, the DSP device 70-4 places bids on the six advertisements AC17 to AC22 to the advertisement delivery apparatus 100 (Step S18-2). Specifically, the DSP device 70-4 places a bid on the advertisement AC17 at a bidding price of XG yen, a bid on the advertisement AC18 at a bidding price of XH yen, a bid on the advertisement AC19 at a bidding price of XI yen, a bid on the advertisement AC20 at a bidding price of XJ yen, a bid on the advertisement AC21 at a bidding price of XK yen, and a bid on the advertisement AC22 at a bidding price XL yen, to the advertisement delivery apparatus 100.

Furthermore, for example, the DSP device 70-5 places bids for the five advertisements AC23 to AC27 to the advertisement delivery apparatus 100 (Step S18-3). Specifically, the DSP device 70-5 places a bid on the advertisement AC23 at a bidding price of XM yen, a bid on the advertisement AC24 at a bidding price of XN yen, a bid on the advertisement AC25 at a bidding price of XO yen, a bid on the advertisement AC26 at a bidding price of XP yen, and a bid on the advertisement AC27 at a bidding price of XQ yen, to the advertisement delivery apparatus 100.

In the manner described above, in the example illustrated in FIG. 1, the advertisement delivery apparatus 100 acquires bid advertisements that will be the candidates for the advertisements to be delivered to the respective advertisement spots AR by holding two separate auctions. The advertisement delivery apparatus 100 then determines the advertisements to be delivered to the respective advertisement spots AR belonging to the second group (Step S19-1). Specifically, the advertisement delivery apparatus 100 determines the advertisements to be delivered to the advertisement spots AR12 to AR17 specified with the time-related condition “normal”.

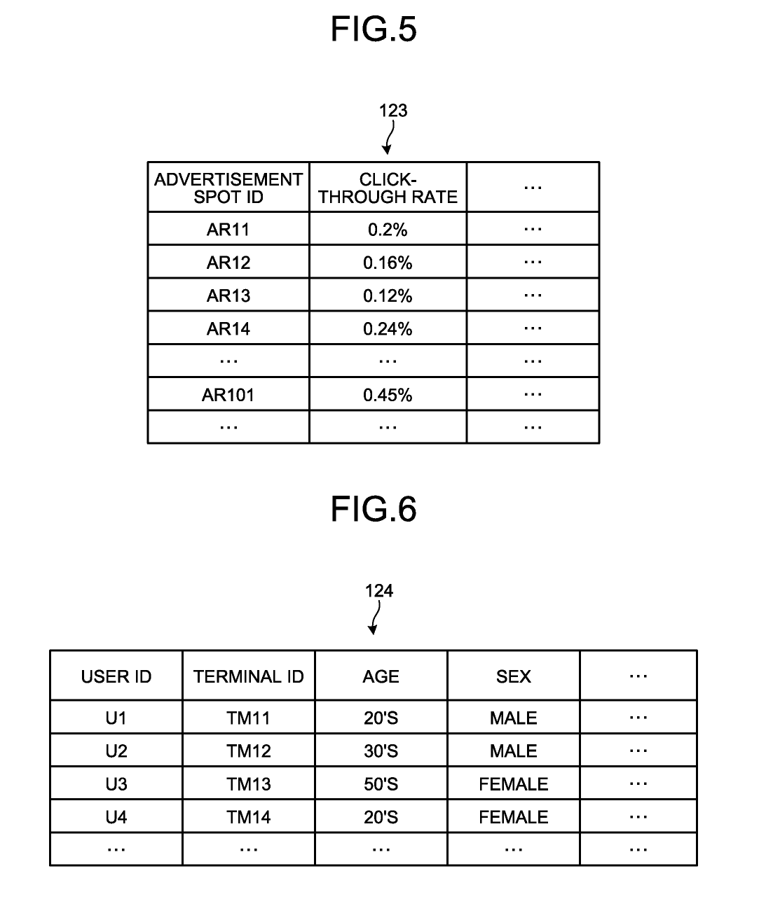

For example, the advertisement delivery apparatus 100 may determine the advertisement to be delivered to the advertisement spots AR belonging to the second group based on the expected overall revenue assuming that each of the bid advertisements is delivered to each of the advertisement spots AR belonging to the second group. For example, the advertisement delivery apparatus 100 calculates the overall expected eCPM based on the bidding price of each of the bid advertisements, assuming each of the bid advertisements is delivered to each of the advertisement spots AR belonging to the second group, based on the records of successful bids on each of the advertisement spots, the record being stored in the advertisement spot information storage unit 123 (see FIG. 5), for example, and may determine the advertisement to be delivered to each of the advertisement spots AR based on the scale of calculated eCPM.

In the example illustrated in FIG. 1, it is assumed that the overall eCPM is maximized when the advertisement AC13 is allocated to the advertisement spot AR12, the advertisement AC17 is allocated to the advertisement spot AR13, the advertisement AC23 is allocated to the advertisement spot AR14, the advertisement AC24 is allocated to the advertisement spot AR15, the advertisement AC18 is allocated to the advertisement spot AR16, and the advertisement AC19 is allocated to the advertisement spot AR17. The advertisement delivery apparatus 100, therefore, determines the advertisement AC13 as the advertisement to be delivered to the advertisement spot AR12, the advertisement AC17 as the advertisement to be delivered to the advertisement spot AR13, the advertisement AC23 as the advertisement to be delivered to the advertisement spot AR14, the advertisement AC24 for the advertisement spot AR15, the advertisement AC18 as the advertisement to be delivered to the advertisement spot AR16, and the advertisement AC19 as the advertisement to be delivered to the advertisement spot AR17.

The advertisement delivery apparatus 100 having determined the advertisements to be delivered at Step S19-1 delivers the six advertisements to be delivered corresponding to the advertisement spots AR12 to AR17, respectively, to the terminal device 10 (Step S19-2). Specifically, the advertisement delivery apparatus 100 delivers the six advertisements AC13, AC17, AC23, AC24, AC18, and AC19 to the terminal device 10 as the advertisements to be delivered. The terminal device 10 having received the advertisements to be delivered displays the advertisement to be delivered to the respective advertisement spots AR12 to AR17, as the advertisement spots AR12 to AR17 are displayed. For example, on the terminal device 10 illustrated in FIG. 1, when the advertisement spot AR12 becomes included in the part being shown on the terminal device 10, the advertisement AC13 is displayed in the advertisement spot AR12.

To simplify the explanation, explained with reference to FIG. 1 is an example in which the advertisement delivery apparatus 100 delivers the advertisements to the terminal device 10, but it is also possible to cause the DSP devices 70 having placed their bids on the advertisements that are determined as the advertisement to be delivered to the terminal device 10 to deliver the advertisements to the terminal device 10. In other words, the advertisement delivery apparatus 100 may be responsible only for determining the advertisement to be delivered to terminal device 10, and any other apparatuses may be responsible for delivering the advertisements. For example, the delivery of the advertisements to the terminal device 10 may be performed by causing the advertisement delivery apparatus 100 to notify the DSP devices 70 of the advertisements to be delivered, so that the notified DSP devices 70 are caused to deliver the advertisements. In the manner described above, the advertisement delivery apparatus 100 may be used only for determining the advertisements to be delivered to the terminal device 10, and may not be responsible for the delivery of the advertisements to the terminal device 10. In other words, the advertisements may be delivered to the terminal device 10 by any apparatus.

As described earlier, the advertisement delivery apparatus 100 classifies the advertisement spots AR into a plurality of groups, and determines the DSP device 70 to which a bid request is to be sent, based on the number of bids the DSP device 70 is permitted to place. The advertisement delivery apparatus 100 then acquires the bid advertisements from the DSP device 70, by holding an auction for each of the groups, or issuing a bid request to the DSP device 70 capable of supporting the number of advertisements to be bid in each of the auctions. The advertisement delivery apparatus 100 then determines the advertisement to be delivered to the terminal device 10, based on the bid advertisement acquired from the DSP device 70. In this manner, the advertisement delivery apparatus 100 can determine the advertisements to be delivered appropriately.

Explained above is an example in which the advertisement spots AR are classified into two groups, one for those included in the first view and the other for the others, but the advertisement delivery apparatus 100 may classify the advertisement spots AR into a plurality of groups based on various conditions. For example, the advertisement delivery apparatus 100 may classify the advertisement spots AR into a plurality of groups based on various conditions, such as the position of each of the advertisement spots AR, or the time spent before the advertisement spot AR is displayed. Furthermore, for example, the advertisement delivery apparatus 100 may classify the advertisement spots AR into a plurality of groups based on the format of the advertisement to be delivered to the advertisement spot AR, or the allowable time before the delivery of the advertisement. Because the advertisement to be delivered to the advertisement spot AR11 included in the first view has a shorter allowable time before the advertisement is displayed, compared with the other advertisement spots AR12 to AR17, as explained using the example FIG. 1, the advertisement delivery apparatus 100 may classify the advertisement spot AR11 into a different group from that including the advertisement spots AR12 to AR17. For example, if an advertisement in a video format is to be displayed in the advertisement spot AR13, among the advertisement spots AR12 to AR17, the advertisement delivery apparatus 100 may classify the advertisement spot AR13 into a group different from that including the advertisement spots AR12, AR14 to AR17, because video advertisements have a larger amount of data, and require longer delivery time, compared with advertisements using characters or images.

Furthermore, for example, the advertisement delivery apparatus 100 may classify the advertisement spots AR into a plurality of groups based on a condition related to the expected revenue of the advertisement to be displayed in the advertisement spot AR. In such a case, the advertisement delivery apparatus 100 may classify the advertisement spots AR into a plurality of groups based on the click-through rate of an advertisement to be displayed in the advertisement spot AR. For example, if the expected revenue of the advertisement to be displayed in the advertisement spot AR14 is greater than the expected revenue of the advertisement to be displayed of the other advertisement spots AR11 to AR13, AR15 to AR17 by a predetermined threshold, among the advertisement spots AR11 to AR17, the advertisement delivery apparatus 100 may classify the advertisement spot AR14 into a different group from the group of the advertisement spots AR11 to AR13, AR15 to AR17. For example, assuming that used as the advertisements to be delivered are pay-per-click advertisements, if there are some advertisement spots AR resulting in a click-through rate equal to or higher than the predetermined threshold when some advertisements are displayed therein, the advertisement delivery apparatus 100 may classify such advertisement spots AR into the same group, as the advertisement spots AR that are highly likely to have higher expected revenues. Furthermore, for example, if there are some advertisement spots AR resulting in click-through rates lower than the predetermined threshold when some advertisements are displayed therein, the advertisement delivery apparatus 100 may then classify such advertisement spots AR into the same group as the advertisement spots AR that are less likely to have higher expected revenues.

Furthermore, for example, the advertisement delivery apparatus 100 may classify the advertisement spots AR into a plurality of groups, based on a condition related to the user using the terminal device 10. For example, among the advertisement spots AR11 to AR17, if the user U1 using the terminal device 10 exhibits a higher click-through rate on the advertisement displayed in the advertisement spot AR15 than those for the advertisements displayed in the other advertisement spot AR11 to AR14, AR16, AR17 by a predetermined threshold, the advertisement delivery apparatus 100 may classify the advertisement spot AR15 and the advertisement spot AR11 to AR14, AR16, AR17 into different groups. Furthermore, for example, among the advertisement spots AR11 to AR17, if female users in their 20's exhibit higher click-through rates for the advertisements displayed in the advertisement spot AR16 than those for the advertisements displayed in the other advertisement spots AR11 to AR15, AR17 by a predetermined threshold, the advertisement delivery apparatus 100 may classify the advertisement spot AR16 and the advertisement spots AR11 to AR15, AR17 into different groups.

The advertisement delivery apparatus 100 may also classify the advertisement spots AR into a plurality of groups, based on the probability at which the advertisement spot AR is displayed on the terminal device 10. For example, when pay-per-impression advertisements are used as the advertisements to be delivered, the advertisement delivery apparatus 100 may classify the advertisement spots AR that are to be displayed on the terminal device 10 at a probability equal to or higher than the predetermined threshold into the same group, as the advertisement spots AR that are highly likely to have higher expected revenues. Furthermore, for example, the advertisement delivery apparatus 100 may also classify the advertisement spots AR that are to be displayed on the terminal device 10 at a probability less than the predetermined threshold into the same group, as the advertisement spot AR that is less likely to have higher expected revenues. Other examples of the way in which the advertisement delivery apparatus 100 classifies the advertisement spot AR into a plurality of groups will be described later in detail.

In the example explained above, the advertisement delivery apparatus 100 may impose a limitation on the time from when a bid request is transmitted to a DSP device 70 to when the bid for the advertisement is acquired. For example, the advertisement delivery apparatus 100 may determine the advertisements to be delivered, only from the advertisement on which a bid is placed within 100 msec. that is the time limit. If there are any bid advertisements that are received before the time limit but do not satisfy the condition for the advertisement to be delivered, for example, the advertisement delivery apparatus 100 may hold an auction again, or extend the time limit.

Furthermore, for example, the advertisement delivery apparatus 100 may change the time limit for placing a bid for the candidate for the advertisement to be delivered to the advertisement spot AR, based on the expected revenue of the advertisement to be displayed in the advertisement spot AR. For example, if the expected revenue of the advertisement to be displayed in the advertisement spot AR is higher, the advertisement delivery apparatus 100 may set a longer time limit for placing a bid on a candidate for the advertisement to be delivered to the advertisement spot AR. Furthermore, for example, the advertisement delivery apparatus 100 may classify a plurality of advertisements into a plurality of groups based on a condition related to a user attribute of the user. If males in their 20's exhibit higher click-through rates when the video advertisements are delivered to the advertisement spot AR13, compared with those when video advertisements are delivered to the other advertisement spots AR, for example, the advertisement delivery apparatus 100 may classify the advertisement spot AR13 and the other advertisement spots AR into different groups when an advertisement request is received from the terminal device 10 of a male user in his 20's.

Furthermore, for example, the advertisement delivery apparatus 100 may change the time limit for placing a bid on a candidate as the advertisement to be delivered to the advertisement spot AR based on the expected revenue of the advertisement to be displayed in the advertisement spot AR. For example, if the expected revenue of the advertisement to be displayed in the advertisement spot AR is higher, the advertisement delivery apparatus 100 may extend the time limit for placing a bid on a candidate as the advertisement to be delivered to the advertisement spot AR. For example, if the expected revenue of the advertisement to be displayed in one advertisement spot AR is higher than those of the advertisement to be displayed in the other advertisement spots AR, the advertisement delivery apparatus 100 may set longer time as the waiting time for the placement of a bid for the candidate for the advertisement to be delivered to the advertisement spot AR, than that used for the other advertisement spots AR. For example, if the expected revenue of the advertisement to be displayed in the advertisement spot AR11 is 1.5 times higher than the expected revenues of the advertisements to be displayed in the advertisement spot AR12, the advertisement delivery apparatus 100 may set 1.5 times longer time as the waiting time for the placement of a bid on a candidate for the advertisement to be delivered to the advertisement spot AR11, than that used for a bid on the advertisement spot AR12. For example, if the expected revenue of the advertisement to be displayed in the advertisement spot AR11 is higher than the average of the expected revenues of the advertisements to be displayed in the advertisement spots AR, by an amount equal to or more than a predetermined threshold, the advertisement delivery apparatus 100 may add a predetermined time (for example, 30 msec.) for the advertisement spot AR11, to the normal waiting time (for example, 100 msec.) for the placement of a bid on a candidate for the advertisement to be delivered.

Furthermore, for example, when the expected revenue of the advertisement provided by some DSP device 70 is higher, the advertisement delivery apparatus 100 may extend the time limit by which the DSP device 70 is permitted to place a bid. For example, if the expected revenue of the advertisement provided by some DSP device 70 is higher than those provided by the other DSP devices 70, the advertisement delivery apparatus 100 may extend the waiting time for that DSP device 70, from that used for the other DSP devices 70. For example, if the advertisement provided by the DSP device 70-1 has an expected revenue 1.5 times higher than the advertisement provided by the DSP device 70-2, the advertisement delivery apparatus 100 may use a 1.5 times longer waiting time for the DSP device 70-1, than that used for the DSP device 70-2. For example, if the advertisement provided by the DSP device 70-1 has an expected revenue that is equal to or higher than a predetermined threshold than the average expected revenue of the advertisements provided by the DSP devices 70, the advertisement delivery apparatus 100 may add a predetermined time (for example, 20 msec.) for the DSP device 70-1, to the normal waiting time (for example, 100 msec.).

For example, the advertisement delivery apparatus 100 may also determine the DSP device 70 to which a bid requested is sent based on the compatibility between the advertisement to be delivered by the DSP device 70 and the user who is to be the receiver of the advertisement. For example, to determine the advertisement to be delivered to the terminal device 10 of the user U1, the advertisement delivery apparatus 100 may send the advertisement bid request to the DSP device 70 having delivered some advertisement to the user U1 in the past and resulted in a higher revenue. For example, if the delivery of the advertisements provided by the DSP devices 70-1, 70-3, and 70-5 to the user U1 has resulted in a higher revenue in the past, than that of the other DSP devices 70, the advertisement delivery apparatus 100 may send advertisement bid requests to the DSP devices 70-1, 70-3, and 70-5 to determine the advertisement to be delivered to the terminal device 10 of the user U1.

Explained above is an example in which the content CT11 corresponding to the “all” column is displayed, but the terminal device 10 may be enabled to switch the column in response to a user operation. For example, when the user U1 selects the “entertainment” column, the terminal device 10 may display a group of pieces of partial content corresponding to the “entertainment” column, that is, content related to entertainment, instead of the content CT11. For example, if the user U1 selects the “sports” column, the terminal device 10 may display a group of pieces of partial content corresponding to the “sports” column, that is, partial content related to sports, instead of the content CT11. The terminal device 10 may acquire the content related to the “entertainment” column or to the “sports” column at the time such content is switched, or may acquire such content in advance.

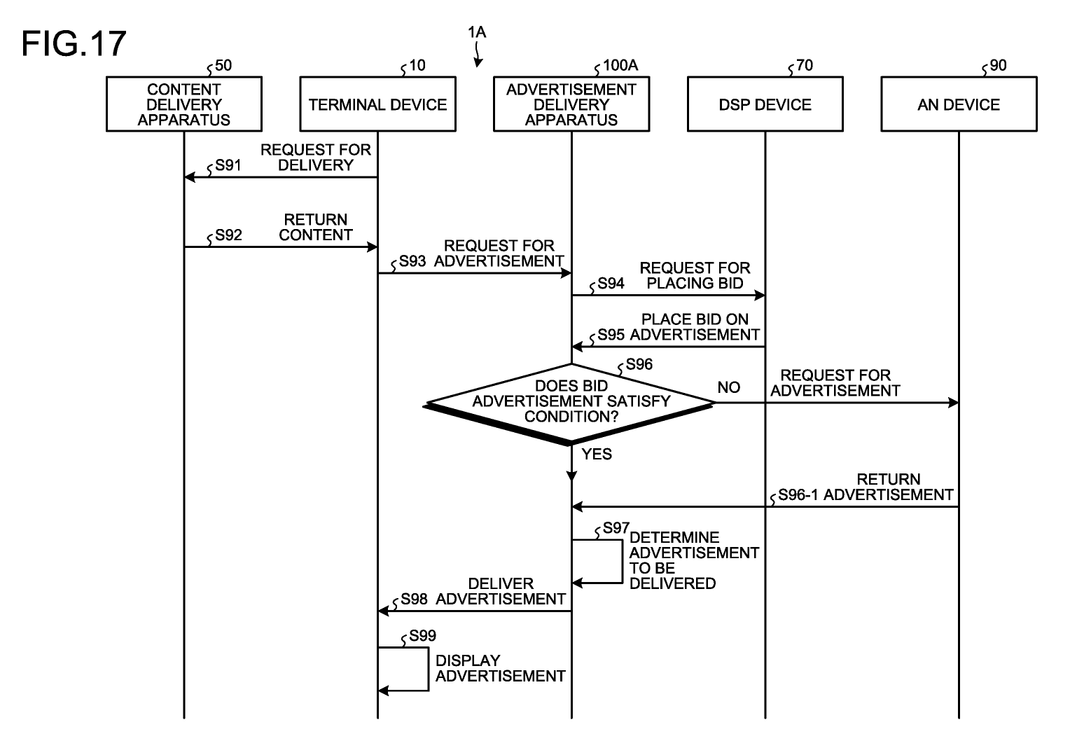

For example, among a plurality of groups of advertisements, the advertisement delivery apparatus 100 may acquire the advertisement from the DSP devices 70 by requesting the advertisements belonging to one of such groups from the DSP devices 70 through auctioning, and acquire the advertisements belonging to the other groups using a scheme other than auctioning. For example, the advertisement delivery apparatus 100 may acquire the advertisements belonging to the other groups from an advertisement providing server on a predetermined advertisement network (for example, an AN device 90 (see FIG. 17)). As another example, when the advertisement delivery apparatus 100 is provided with an advertisement information storage unit storing therein advertisements, the advertisement delivery apparatus 100 may acquire the advertisements belonging to the other groups from the advertisement information storage unit provided thereto.

The advertisement delivery apparatus 100 may also determine, as the advertisement to be delivered to an advertisement spot included in the content corresponding to the “entertainment” column, an advertisement that is highly affinitive to the entertainment category. Furthermore, for example, the advertisement delivery apparatus 100 may also determine, as an advertisement to be delivered to an advertisement spot included in the content corresponding to the “sports” column, an advertisement that is highly affinitive to the sports category. Explained above is an example in which the terminal device 10 is a smartphone, and the pieces of partial content and advertisement spots AR are arranged in a predetermined direction (vertical direction) in the content, but the terminal device 10 and the content may be implemented in various ways. For example, the terminal device 10 may also be a PC, for example. The arrangement of the content is also not limited to the vertical direction, and the partial content and the advertisement spots AR may be arranged in the horizontal and vertical directions, that is, two-dimensionally (in a grid-like shape).

2. Configuration of Advertisement Delivery Apparatus

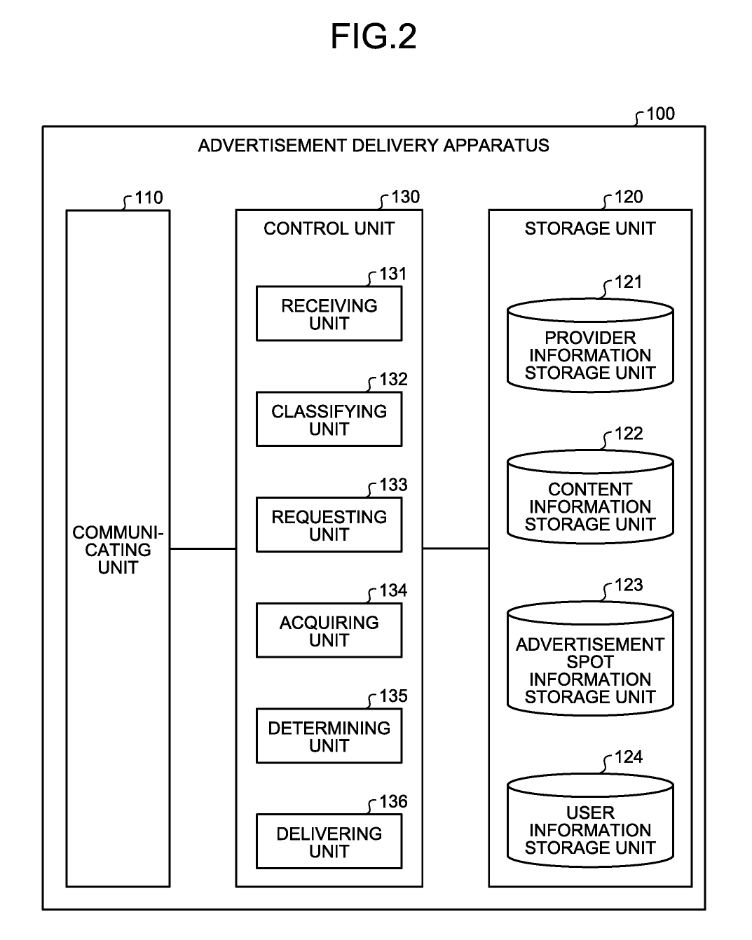

A configuration of the advertisement delivery apparatus 100 according to the embodiment will now be explained with reference to FIG. 2. FIG. 2 is a schematic illustrating an exemplary configuration of the advertisement delivery apparatus 100 according to the embodiment. As illustrated in FIG. 2, the advertisement delivery apparatus 100 includes a communicating unit 110, a storage unit 120, and a control unit 130. The advertisement delivery apparatus 100 may also include an input unit (such as a keyboard and a mouse) for receiving various operations from an administrator or the like of the advertisement delivery apparatus 100, and a display unit (such as a liquid crystal display) for displaying various types of information.

Communicating Unit 110

The communicating unit 110 is implemented as a network interface card (NIC), for example. The communicating unit 110 is connected to a network over the wire or wirelessly, and transmits and receives information to and from the terminal device 10.

Storage Unit 120

The storage unit 120 is implemented as a random access memory (RAM), a semi-conductor memory device such as a flash memory, or a storage device such as a hard disk or an optical disc, for example. The storage unit 120 according to the embodiment includes, as illustrated in FIG. 2, a provider information storage unit 121, a content information storage unit 122, an advertisement spot information storage unit 123, and a user information storage unit 124.

Provider Information Storage Unit 121

The provider information storage unit 121 according to the embodiment stores therein various types of information related to the advertisements. FIG. 3 illustrates an example of the provider information storage unit 121 according to the embodiment. The provider information storage unit 121 illustrated in FIG. 3 includes items such as “provider ID”, “advertisement ID”, “format”, “impression count”, and “click-through rate”.

The “provider ID” represents identification information for identifying the provider that provides an advertisement. The “advertisement ID” represents identification information for identifying the advertisement. The “format” represents the data format of the advertisement. The “impression count” represents the number of times at which the advertisement is displayed on the terminal device 10. The “click-through rate” represents the CTR, and is the ratio of the number of times at which the advertisement is clicked, with respect to the impression count of the advertisement.

For example, the example illustrated in FIG. 3 represents that the provider identified by a provider ID “DSP70-1” (corresponding to the “DSP device 70-1”) is the advertisement providing server providing the advertisement identified by an advertisement ID “AC11” (corresponding to the “advertisement AC11”) and the advertisement identified by an advertisement ID “AC110”, and that the advertisement identified by the advertisement ID “AC11” has a format of “image and characters”, an impression count of “1000” times, and a click-through rate of “0.2 percent”.

The provider information storage unit 121 may store therein various types of information depending on its purpose, without limitation to the example described above. The provider information storage unit 121 may store therein the acceptable number of bids corresponding to each provider. For example, the provider information storage unit 121 may store therein, for each provider, the number of advertisements for which the provider receives a bid request at one time. For example, the provider information storage unit 121 may store therein the click count of each advertisement. For example, the provider information storage unit 121 may also store therein identification information for identifying the advertiser. There are cases in which advertisers request advertising agencies to submit their advertisements, therefore, the term “advertiser” has a concept including not only advertisers but also advertising agencies. Furthermore, for example, the provider information storage unit 121 may also store therein information indicating the name of the product or the service that is the subject of each advertisement. Without limitation to the “product name”, the provider information storage unit 121 may also store therein information such as a “product ID” for identifying the product, as the information indicating the product or the like.

Content Information Storage Unit 122

The content information storage unit 122 according to the embodiment stores therein various types of information related to content. FIG. 4 is a schematic illustrating an example of the content information storage unit according to the embodiment. For example, the content information storage unit 122 stores therein information related to the layout of partial content and an advertisement spot included in a piece of content delivered by the content delivery apparatus 50. The content information storage unit 122 illustrated in FIG. 4 includes items such as “content ID” and “delivery information”. The “delivery information” includes items such as “displayed position 1”, “displayed position 2”, “displayed position 3”, and “displayed position 4”.

The “content ID” represents identification information for identifying a piece of content. The “displayed position 1” points to a predetermined displayed position in the content identified by the corresponding content ID. For example, in the content CT11 illustrated in FIG. 1, the “displayed position 1” points to the position at which content A is displayed. The “displayed position 2”, the “displayed position 3”, and the “displayed position 4” point to predetermined displayed positions in the content identified by the corresponding content ID. In the content CT11 illustrated in FIG. 1, the “displayed position 2” points to the position at which content B is displayed, and the “displayed position 3” points to the position to which the advertisement spot AR11 is provided. The “displayed position 4” points to the position at which content C is displayed.

For example, the example illustrated in FIG. 4 represents that, in the content identified by the content ID “CT11” (corresponding to the content CT11), the content A is displayed at the “displayed position 1”, the content B is displayed at the “displayed position 2”, the advertisement spot AR11 is provided at the “displayed position 3”, and the content C is displayed at the “displayed position 4”.

The content information storage unit 122 may store therein various types of information depending on its purpose, without limitation to the example described above. For example, the content information storage unit 122 may store therein information related to the specific position of each piece of partial content and advertisement spot in the content. For example, the content information storage unit 122 may establish a predetermined position in the content as a point of origin, and store therein a relative position of each piece of partial content or advertisement spot with respect to the point of origin. For example, the content information storage unit 122 may also store therein information related to the size of each piece of partial content or advertisement spot. Furthermore, for example, the content information storage unit 122 may store therein information related to the size occupied by each piece of partial content or advertisement spot.

Advertisement Spot Information Storage Unit 123

The advertisement spot information storage unit 123 according to the embodiment stores therein information related to advertisement spots. FIG. 5 illustrates an example of the information related to the advertisement spots, stored in the advertisement spot information storage unit 123. As illustrated in FIG. 5, the advertisement spot information storage unit 123 includes items such as “advertisement spot ID” and “click-through rate”, as the information related to advertisement spots.

The “advertisement spot ID” represents identification information for identifying an advertisement spot. The “click-through rate” represents a CTR, and represents the ratio of the number of times at which the advertisement displayed in the advertisement spot is clicked, with respect to the impression count of the advertisement in that advertisement spot.

For example, the example illustrated in FIG. 5 represents that, the click-through rate of the advertisement spot AR11 is “0.2 percent”. As other examples, the example represents that the click-through rate of the advertisement spot AR12 is “0.16 percent”, the click-through rate of the advertisement spot AR13 is “0.12 percent”, the click-through rate of the advertisement spot AR14 is “0.24 percent”, and the click-through rate of the advertisement spot AR101 is “0.45 percent”.

The advertisement spot information storage unit 123 may store therein various types of information, depending on its purpose, without limitation to the example described above, as long as such information is the information related to advertisement spots. For example, the advertisement spot information storage unit 123 may store therein information related to the content including the advertisement spot, or information related to the position at which the advertisement spot is allocated.

User Information Storage Unit 124

The user information storage unit 124 according to the embodiment stores therein various types of information related to users. For example, the user information storage unit 124 stores therein various types of information related to user attributes. FIG. 6 is a schematic illustrating an example of the user information storage unit according to the embodiment. The user information storage unit 124 illustrated in FIG. 6 includes items such as “user ID”, “terminal ID”, “age”, and “sex”.

The “user ID” represents identification information for identifying the user. For example, the user identified by the user ID “U1” corresponds to the user U1 illustrated in the example of FIG. 1. The “terminal ID” is identification information for identifying the terminal device 10. For example, the terminal device 10 identified by the terminal ID “TM11” corresponds to the terminal device 10 used by the user U1 illustrated in the example of FIG. 1. The “age” represents the age of the user identified by the user ID. The “age” may be the specific age, e.g., 35 years old, of the user identified by the user ID. The “sex” represents the sex of the user identified by the user ID.

For example, the example illustrated in FIG. 6 represents that the terminal device 10 used by the user identified by the user ID “U1” is a terminal device 10 identified by a terminal ID “TM11”, and that the age of the user identified by the user ID “U1” is in his “20's”, and sex is “male”.

The user information storage unit 124 may store therein various types of information depending on its purpose, without limitation to the example described above. For example, the user information storage unit 124 may store therein information related to a demographic attribute or a psychographic attribute of the user. For example, the user information storage unit 124 may store therein information such as a home location, a work location, interests and concerns, a full name, family members, and income.

Control Unit 130

Returning to the explanation of FIG. 2, the control unit 130 is a controller, and is implemented by causing a central processing unit (CPU) or a micro processing unit (MPU), for example, to execute various types of computer programs (corresponding to an example of an advertisement delivery program) stored in the storage device provided internally to the advertisement delivery apparatus 100, using the RAM as a working area. The control unit 130 is a controller, and may also be implemented as an integrated circuit such as an application specific integrated circuit (ASIC) or a field programmable gate array (FPGA).

As illustrated in FIG. 2, the control unit 130 includes a receiving unit 131, a classifying unit 132, a requesting unit 133, an acquiring unit 134, a determining unit 135, and a delivering unit 136, and implements or executes the functions and actions of an advertisement delivery process explained below. The internal configuration of the control unit 130 is not limited to the configuration illustrated in FIG. 2, and may be any other configuration as long as such a configuration performs the advertisement delivery process described later.

Receiving Unit 131

The receiving unit 131 receives an advertisement delivery request from the terminal device 10. For example, the receiving unit 131 receives a delivery request for a plurality of advertisements from the terminal device 10. For example, the receiving unit 131 receives a delivery request for a plurality of advertisements to be displayed in the respective displayed positions (corresponding to the respective advertisement spots AR in FIG. 1; the same applies in the following) in one piece of content (corresponding to the content CT11 in FIG. 1; the same applies in the following), from the terminal device 10 on which one piece of content is to be displayed. In FIG. 1, the receiving unit 131 receives an advertisement request for the advertisements to be displayed in the respective advertisement spots AR11 to AR17 included in the content CT11, from the terminal device 10.

Furthermore, for example, the receiving unit 131 receives a delivery request for a plurality of advertisements the number of which is determined based on the information related to one piece of content or the information related to user using the terminal device 10. Furthermore, for example, the receiving unit 131 receives a delivery request for a plurality of advertisements whose formats are determined based on the information related to one piece of content, or the information related to the user using the terminal device 10.

Classifying Unit 132

The classifying unit 132 classifies a plurality of advertisements (corresponding to the advertisement spots AR in FIG. 1; the same applies in the following) for which a delivery request to be received by the receiving unit 131 into a plurality of groups, based on a predetermined condition. For example, the classifying unit 132 classifies the advertisements into a plurality of groups based on a time-related condition assigned to each of such advertisements. For example, the classifying unit 132 classifies the advertisements into a plurality of groups based on a time-related condition assigned to each of the advertisements depending to the position at which the advertisement is displayed. For example, the classifying unit 132 classifies the advertisements into a plurality of groups based on a time-related condition related to the time spent before each of the advertisements is displayed on the terminal device 10.

Furthermore, for example, the classifying unit 132 classifies the advertisements into a plurality of groups based on a condition related to the expected revenue from delivering the advertisement, in response to a delivery request. For example, the classifying unit 132 classifies the advertisements into a plurality of groups based on a condition related to the user using the terminal device 10. For example, the classifying unit 132 classifies the advertisements into a plurality of groups based on a condition related to the history of behavior of the user. Furthermore, for example, the classifying unit 132 classifies the advertisements into a plurality of groups based on a condition related to a user attribute of the user.

For example, the classifying unit 132 classifies the advertisements into a plurality of groups based on a condition related to the position at which each of the advertisements is displayed. Furthermore, for example, the classifying unit 132 classifies the advertisements into a plurality of groups based on a condition related to the format in which each of the advertisements is displayed.

Requesting Unit 133

The requesting unit 133 requests the DSP devices 70 to place their bids on their advertisements. In FIG. 1, the requesting unit 133 requests the DSP devices 70 to place their bids on their advertisements that will be candidates for the advertisement to be delivered to the advertisement spot AR included in the first group (advertisement spot AR11). For example, the requesting unit 133 requests the DSP devices 70-1, 70-2 to place their bids on their advertisements, for the advertisement spot AR11 included in the first group.

In FIG. 1, the requesting unit 133 also requests the DSP devices 70 to place their bids on their advertisements that will be candidates for the advertisements to be delivered to the advertisement spots AR included in the second group (advertisement spots AR12 to AR17). For example, the requesting unit 133 requests the DSP devices 70-3 to 70-5 to place their bids on their advertisements, for the advertisement spots AR12 to AR17 included in the second group.

Acquiring Unit 134

The acquiring unit 134 acquires the advertisements from the advertisement providing servers (corresponding to the DSP devices 70 in FIG. 1; the same applies in the following) by requesting the advertisements from the advertisement providing servers, in response to a delivery request received by the receiving unit 131. In FIG. 1, the acquiring unit 134 acquires the bid advertisements from the DSP devices 70 from which the placement of bids for the advertisements is requested by the requesting unit 133. The acquiring unit 134 also acquires information related to the bidding price of the bid advertisement, from the DSP devices 70 from which the placement of bids for the advertisements is requested by the requesting unit 133.

In FIG. 1, for example, the acquiring unit 134 acquires the advertisement AC11 from the DSP device 70-1 as a bid advertisement at a bidding price of XA yen. Furthermore, for example, the acquiring unit 134 acquires the advertisement AC12 from the DSP device 70-2 as a bid advertisement at a bidding price of XB yen.

For example, the acquiring unit 134 acquires the advertisements from a plurality of advertisement provider servers by requesting the advertisements from the advertisement provider servers. For example, the acquiring unit 134 acquires the advertisements from a plurality of advertisement provider servers based on information related to the records of successful advertisement bids, acquired from the respective advertisement provider servers.

Furthermore, for example, the acquiring unit 134 acquires advertisements from the advertisement providing servers by requesting the advertisements from the advertisement providing servers, based on the types of requests that can be accepted by the advertisement providing server. For example, the acquiring unit 134 acquires the advertisements from the advertisement providing servers by requesting the advertisements from the advertisement providing servers based on the advertisement format for which the advertisement providing servers are permitted to place a bid. For example, the acquiring unit 134 acquires the advertisements from the advertisement providing servers by requesting the advertisements from the advertisement providing servers based on the number of advertisements for which the advertisement providing servers are permitted to place a bid.

Furthermore, for example, the acquiring unit 134 acquires the advertisements from the advertisement providing servers by requesting the advertisements from the advertisement providing servers for each of a plurality of groups into which the displayed positions are divided. For example, the acquiring unit 134 acquires the advertisements from the advertisement providing servers by requesting the advertisements from the advertisement providing servers for each of a plurality of groups into which the displayed positions are divided based on their positions in one piece of content. For example, the acquiring unit 134 acquires the advertisements from the advertisement providing servers by requesting the advertisements from the advertisement providing servers for each of a plurality of groups into which the displayed positions are divided based on the format corresponding to each of the displayed positions.

For example, the acquiring unit 134 acquires the advertisements from the advertisement providing servers by requesting the advertisements from the advertisement providing servers for each of a plurality of groups into which the displayed positions are divided, based on a time-related condition for delivering advertisement to the terminal device 10. For example, the acquiring unit 134 acquires the advertisements from the advertisement providing servers by requesting the advertisements from the advertisement providing servers for each of a plurality of groups into which the displayed positions are divided, such groups including groups for collecting records of successful bids.

Furthermore, for example, the acquiring unit 134 acquires the advertisements from the advertisement providing servers using an acquisition scheme that is changed depending on a receiver condition that is a condition related to the receiver of the advertisement, and on a provider condition that is a condition related to the provider providing the advertisement. For example, the acquiring unit 134 acquires the advertisements from the advertisement providing servers based on the advertisement format that varies depending on the receiver condition and the provider condition. For example, the acquiring unit 134 acquires the advertisements from the advertisement providing servers that are determined as the addressees of the advertisement request based on the receiver condition and the provider condition.

Furthermore, for example, the acquiring unit 134 acquires the advertisements from the advertisement providing servers based on the waiting time for waiting for a response from the advertisement providing servers, the waiting time varying depending on the receiver condition and the provider condition. For example, the acquiring unit 134 acquires the advertisements from the advertisement providing servers based on the waiting time that varies depending on the expected revenues that are estimated assuming that the advertisements are delivered. For example, the acquiring unit 134 acquires the advertisements from the advertisement providing servers based on the waiting time that is extended when the expected revenue is higher.

Furthermore, for example, the acquiring unit 134 acquires the advertisements from the advertisement providing servers based on the acquisition scheme that is changed depending on a receiver condition, including a condition related to the content in which the advertisement is displayed. For example, the acquiring unit 134 acquires the advertisements from the advertisement providing servers based on the acquisition scheme that is changed depending on the receiver condition, including a condition related to the position at which the advertisement is displayed in the content. For example, the acquiring unit 134 acquires the advertisements from the advertisement providing servers based on the acquisition scheme that is changed depending on the receiver condition, including a condition related to the position at which the advertisement is displayed in the content where the advertisement and the partial content are arranged in a predetermined direction.

For example, the acquiring unit 134 acquires the advertisements from the advertisement providing servers based on the acquisition scheme that is changed depending on the receiver condition, including a condition related to the position at which the advertisement is displayed in the content in which the portions to be shown and to be hidden on the terminal device 10 can be switched by a user operation. For example, the acquiring unit 134 acquires the advertisements from the advertisement providing servers based on the acquisition scheme that is changed depending on the receiver condition, including a condition related to the time spent before the advertisement in the hidden portion is displayed on the terminal device 10 by the user operation.

Furthermore, for example, the acquiring unit 134 acquires the advertisements from the advertisement providing servers based on the acquisition scheme that is changed depending on the receiver condition, including a condition related to the user using the terminal device 10. For example, the acquiring unit 134 acquires the advertisements from the advertisement providing servers based on the acquisition scheme that is changed depending on the receiver condition, including a condition related to the history of behavior of the user. For example, the acquiring unit 134 acquires the advertisements from the advertisement providing servers based on the acquisition scheme that is changed depending on the receiver condition, including a condition related to the user attributes of the user.

Furthermore, for example, the acquiring unit 134 acquires the advertisements from the advertisement providing servers based on the acquisition scheme that is changed depending on the receiver condition, including the types of requests that can be accepted by the advertisement providing servers. For example, the acquiring unit 134 acquires the advertisements from the advertisement providing servers based on the acquisition scheme that is changed depending on the receiver condition, including a data format of the advertisements on which the advertisement providing servers are permitted to place a bid. For example, the acquiring unit 134 acquires the advertisements from the advertisement providing servers based on the acquisition scheme that is changed depending on the receiver condition, including the number of advertisements on which advertisement providing servers are permitted to place a bid.

Furthermore, for example, the acquiring unit 134 acquires the advertisements from the advertisement providing servers by requesting the advertisements from the advertisement providing servers for each of a plurality of groups.

Determining Unit 135

The determining unit 135 determines the advertisement to be delivered to the terminal device 10, based on the advertisements acquired by the acquiring unit 134. For example, the determining unit 135 determines the advertisement to be delivered for each of the groups classified by the classifying unit 132. For example, the determining unit 135 determines the advertisement to be delivered to the terminal device 10 based on the advertisements acquired by the acquiring unit 134 and the displayed positions in one piece of content. For example, the determining unit 135 determines the advertisement to be delivered to the terminal device 10 based on the expected revenues of the advertisements acquired by the acquiring unit 134. For example, the determining unit 135 determines the advertisement to be delivered to the terminal device 10 based on the entire expected revenue of the advertisements displayed in one piece of content. For example, the determining unit 135 determines the advertisement to be delivered to the terminal device based on the expected revenues of the advertisements that change depending on the positions where the advertisements are displayed in one piece of content. For example, the determining unit 135 determines the advertisement to be delivered to the terminal device 10 based on the expected revenues of the advertisements that change based on the behavior information of the user using the terminal device 10. For example, the determining unit 135 determines the advertisement to be delivered to the terminal device 10 based on the expected revenues of the advertisements that change depending on the information related to the user operation history performed on one piece of content and the positions to be displayed in one piece of content.

Delivering Unit 136

The delivering unit 136 delivers the advertisements to be delivered, determined by the determining unit 135, to the terminal device 10. In the example illustrated in FIG. 1, the delivering unit 136 delivers the seven advertisements to be delivered, corresponding to the advertisement spots AR, respectively, to the terminal device 10. For example, the delivering unit 136 delivers the seven advertisements including the advertisements AC12, AC13, AC17, AC23, AC24, AC18, and AC19 to the terminal device 10, as the advertisements to be delivered.

3. Configuration of Terminal Device

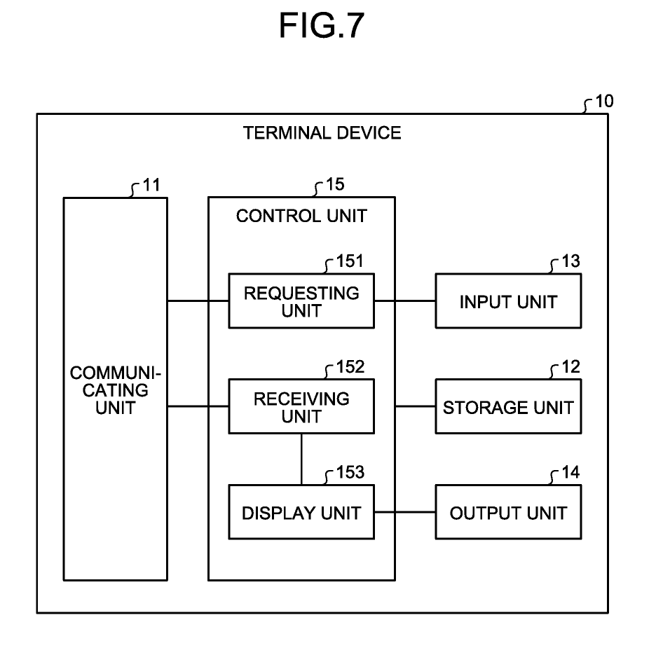

A configuration of the terminal device 10 according to the embodiment will now be explained with reference to FIG. 7. FIG. 7 is a schematic illustrating an exemplary configuration of the terminal device 10 according to the embodiment. As illustrated in FIG. 7, the terminal device 10 includes a communicating unit 11, a storage unit 12, an input unit 13, an output unit 14, and a control unit 15.

Communicating Unit 11

The communicating unit 11 is implemented as a communication circuit, for example. The communicating unit 11 is connected to a predetermined network, not illustrated, over the wire or wirelessly, and transmits and receives information to and from the advertisement delivery apparatus 100 and the content delivery apparatus 50. The communicating unit 11 may also transmit and receive information to and from the DSP devices 70.

Storage Unit 12

The storage unit 12 is implemented as a RAM, a semi-conductor memory device such as a flash memory, a storage device such as a hard disk and an optical disc, for example. The storage unit 12 stores therein information related to the applications, e.g., computer programs, installed on the terminal device 10.

Input Unit 13

The input unit 13 receives various operations from the user. For example, the input unit 13 may receive such various operations from the user via the display surface (such as the display unit 153) having a touch panel function. The input unit 13 may receive various operations from a button provided to the terminal device 10, or a keyboard or a mouse connected to the terminal device 10.

Output Unit 14

The output unit 14 is a display screen of a tablet terminal or the like, implemented as a liquid crystal display or an electro-luminescence (EL) display, for example, and is a display device for displaying various types of information.

Control Unit 15

The control unit 15 is a controller, and is implemented by causing a CPU or an MPU, for example, to execute the various computer programs stored in a storage device such as the storage unit 12 that is provided internally to the terminal device 10, using the RAM as a working area. For example, these various computer programs include application programs installed on the terminal device 10. The control unit 15 is a controller, and is implemented as an integrated circuit such as an ASIC or an FPGA, for example.

As illustrated in FIG. 7, the control unit 15 includes a requesting unit 151, a receiving unit 152, and a display unit 153, and implements or executes the functions and actions of the displaying process which will be explained later. The internal configuration of the control unit 15 is not limited to the configuration illustrated in FIG. 7, and may be any other configuration as long as such a configuration performs the displaying process described later. A relation in which the processing units included in the control unit 15 are connected is not limited to the relation illustrated in FIG. 7, and may be any other relation.

The requesting unit 151 transmits a delivery request to the content delivery apparatus 50 in response to a user operation received by the input unit 13. For example, the requesting unit 151 transmits a delivery request issued by an application, such as a browser, having been started, to the content delivery apparatus 50. The requesting unit 151 also requests the delivery of an advertisement from the advertisement delivery apparatus 100, in response to a user operation received by the input unit 13. For example, when the content acquired from the content delivery apparatus 50 includes some advertisement spot, the requesting unit 151 requests the delivery of the advertisement from the advertisement delivery apparatus 100. For example, when the content CT11 acquired from the content delivery apparatus 50 includes the advertisement spots AR11 to AR17, the requesting unit 151 transmits an advertisement request to the advertisement delivery apparatus 100.

The receiving unit 152 receives the content delivered by the content delivery apparatus 50. For example, the receiving unit 152 receives the content CT11 including the advertisement spots AR11 to AR17 from the content delivery apparatus 50. The receiving unit 152 also receives the advertisements delivered by the advertisement delivery apparatus 100. As an example, the receiving unit 152 receives the advertisements to be displayed in the advertisement spots AR11 to AR17 from the advertisement delivery apparatus 100. The receiving unit 152 may also receive the advertisements from the DSP devices 70.

The display unit 153 displays the partial content or the advertisement received by the receiving unit 152. For example, the display unit 153 displays the content A and the like included in the content CT11, and displays the advertisement AC12 and the like in the advertisement spots AR included in the content CT11.

The process such as the displaying process performed by the control unit 15 may be implemented by JavaScript (registered trademark), for example. When the displaying process described above is executed by a predetermined application, or when the displaying process is executed by a dedicated application, the control unit 15 may also include an application control unit that controls the predetermined application or the dedicated application, for example.

4. Sequence of Process

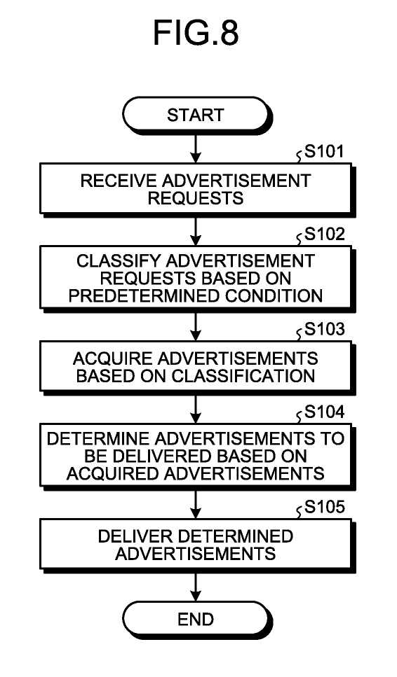

The sequence of the advertisement delivery process executed by the delivery system 1 according to the embodiment will now be explained with reference to FIG. 8. FIG. 8 is a flowchart illustrating an example of the advertisement delivery process according to the embodiment.

As illustrated in FIG. 8, the receiving unit 131 in the advertisement delivery apparatus 100 receives advertisement requests (Step S101). For example, the receiving unit 131 receives the advertisement requests from the terminal device 10.

The classifying unit 132 in the advertisement delivery apparatus 100 then classifies the advertisement requests based on a predetermined condition (Step S102). For example, the classifying unit 132 classifies the advertisement spots AR11 to AR17 corresponding to the advertisement requests based on a predetermined condition. In FIG. 1, the classifying unit 132 classifies the advertisement spots AR11 to AR17 into the first group (advertisement spot AR11) and the second group (advertisement spots AR12 to AR17).

The acquiring unit 134 in the advertisement delivery apparatus 100 acquires the advertisements based on the classification (Step S103). For example, by causing the requesting unit 133 in the advertisement delivery apparatus 100 to request the advertisements from the advertisement providing servers based on the classification, the acquiring unit 134 acquires the advertisements based on the classification. In FIG. 1, for the first group (advertisement spot AR11), the acquiring unit 134 acquires the bid advertisements from the DSP devices 70-1, 70-2. In FIG. 1, for the second group (advertisement spots AR12 to AR17), the acquiring unit 134 acquires the bid advertisements from the DSP devices 70-3 to 70-5.

The determining unit 135 in the advertisement delivery apparatus 100 then determines the advertisements to be delivered based on the acquired advertisements (Step S104). In FIG. 1, the determining unit 135 determines the seven advertisements including the advertisements AC12, AC13, AC17, AC23, AC24, AC18, AC19, as the advertisements to be delivered.

The delivering unit 136 in the advertisement delivery apparatus 100 then delivers the advertisements determined by the determining unit 135 (Step S105). In FIG. 1, the delivering unit 136 delivers the seven advertisements including the advertisements AC12, AC13, AC17, AC23, AC24, AC18, AC19 to the terminal device 10, as the advertisements to be delivered.

5. Advertisement Acquisition Scheme

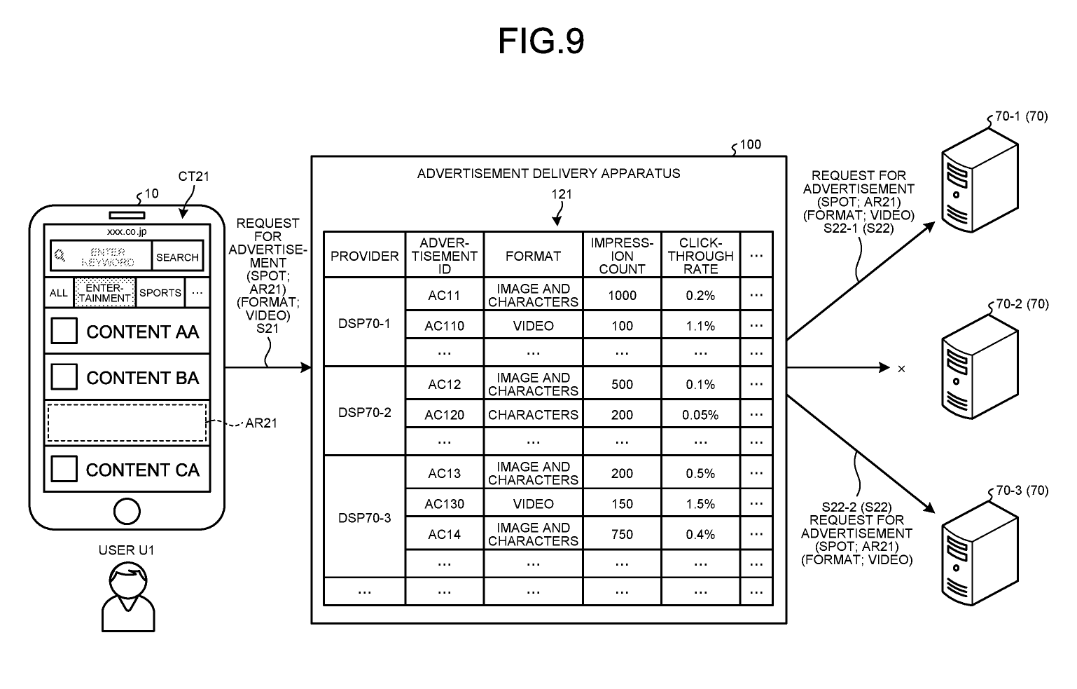

The advertisement acquisition scheme described above is merely an example, and the advertisement delivery apparatus 100 may acquire the advertisements from the DSP devices 70 using various acquisition schemes. This point will now be explained with reference to FIGS. 9 to 15, using some examples of the acquisition schemes.

5-1. Format-Based Determination of Addressee of Request

For example, the advertisement delivery apparatus 100 may determine the addressee of the request based on the format of the advertisement to be delivered. This point will now be explained with reference to FIG. 9. The example illustrated in FIG. 9 indicates an example in which the DSP device 70-2 is not permitted to receive a bid request for an advertisement in a video format. In the example illustrated in FIG. 9, it is assumed that the terminal device 10 has received content CT21 including an advertisement spot AR21 from the content delivery apparatus 50.

To begin with, the terminal device 10 transmits an advertisement request for the advertisement to be displayed in the advertisement spot AR21 that is included in the received content CT21 to the advertisement delivery apparatus 100 (Step S21). In the example illustrated in FIG. 9, the terminal device 10 requests an advertisement in a video format, as the advertisement to be displayed in the advertisement spot AR21, from the advertisement delivery apparatus 100. For example, the terminal device 10 may determine the format of the advertisement to be displayed in the advertisement spot AR21 as video based on the information related to the content CT21 or on the information related to the user U1 using the terminal device 10. The format of the advertisement to be displayed in the advertisement spot AR21 may also be determined by the advertisement delivery apparatus 100, based on the user information of the user using the terminal device 10, the information related to the content CT21, or the information related to the advertisement spot AR.

The advertisement delivery apparatus 100 having received the request for the advertisement to be displayed in the advertisement spot AR21 requests the DSP devices 70 to place their bids on their advertisements, based on the video format of the advertisement to be delivered to the advertisement spot AR21 (Step S22). In the example illustrated in FIG. 9, the advertisement delivery apparatus 100 requests the DSP device 70-1 to place a bid on the advertisement in a video format, for the advertisement spot AR21 (Step S22-1), and requests the DSP device 70-3 to place a bid on the advertisement in a video format (Step S22-2). In other words, the advertisement delivery apparatus 100 does not request the DSP device 70-2 that is not permitted to receive a bid request for an advertisement in a video format to place a bid on the advertisement in the advertisement spot AR21. The advertisement delivery apparatus 100 then determines the advertisement to be delivered to the advertisement spot AR21 based on the bid advertisements from the DSP devices 70-1, 70-3, and the like.

Explained above is an example in which the DSP device 70-2 is not permitted to receive any bid request for an advertisement in a video format, but the advertisement delivery apparatus 100 may change the addressee of the request for the placement of a bid on an advertisement in each format, depending on various conditions. For example, if the past revenue resulting from the bid advertisement of the DSP device 70-2 in a video format is less than a predetermined threshold, the advertisement delivery apparatus 100 may exclude the DSP device 70-2 from the addressee of a bid request for an advertisement to be delivered in a video format. In the manner described above, the advertisement delivery apparatus 100 changes the addressee of a bid request based on the format of the advertisement to be delivered to the advertisement spot AR, or based on the condition permitting each of the DSP devices 70 to make delivery, for example. In this manner, the advertisement delivery apparatus 100 can determine the advertisement to be delivered appropriately, by sending a bid request for an advertisement only to the appropriate addressees of the request.

5-2. Format-Based Classification

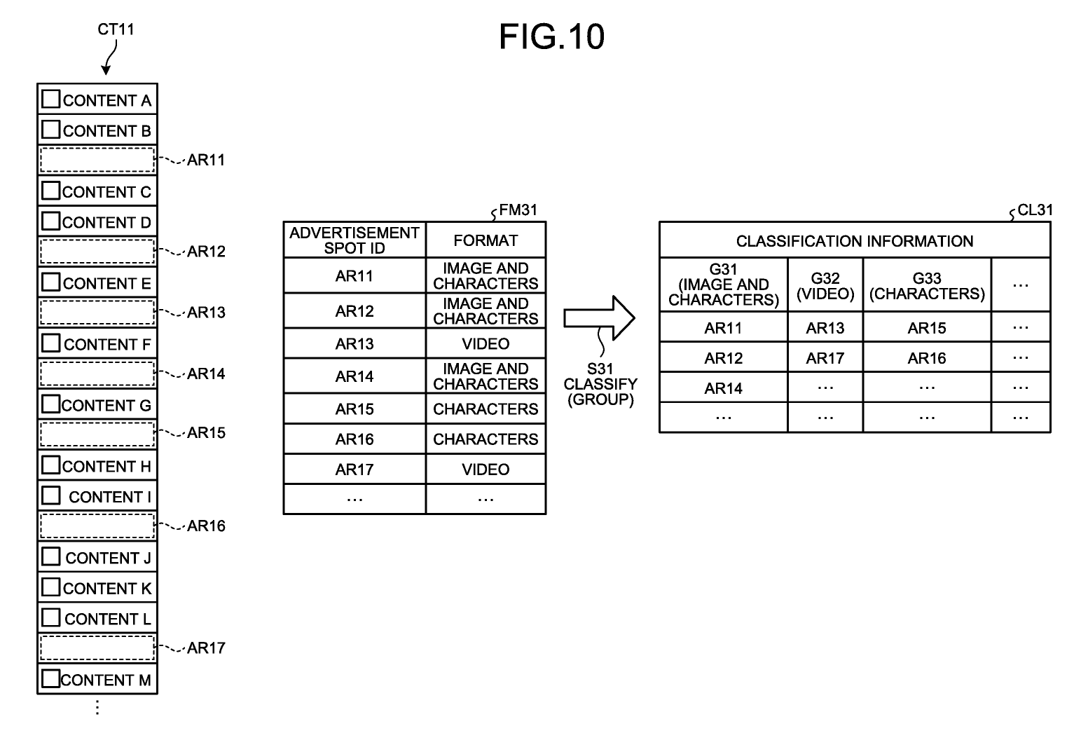

Explained in the embodiment above is an example in which the advertisement delivery apparatus 100 classifies the advertisement spot AR into a plurality of groups based on whether each of the advertisement spots AR is included in the first view, but the advertisement delivery apparatus 100 may classify the advertisement spots AR into a plurality of groups based on various conditions. For example, the advertisement delivery apparatus 100 may classify the advertisement spots AR into a plurality of groups based on the formats of the advertisements to be delivered to the respective advertisement spots AR. This point will now be explained with reference to FIG. 10. The content CT11 in FIG. 10 is the same as the content CT11 in FIG. 1.

In the example illustrated in FIG. 10, it is assumed that the formats of the advertisements to be delivered to the respective advertisement spots AR are determined as indicated in a format list FM31. It is also assumed that, as an example, the format of the advertisement to be delivered to the advertisement spot AR11 is “image and characters”; the format of the advertisement to be delivered to the advertisement spot AR12 is “image and characters”; and the format of the advertisement to be delivered to the advertisement spot AR13 is “video”, as indicated in the format list FM31.

The formats of the advertisements to be delivered to the respective advertisement spots AR, as indicated in the format list FM31, may be received from the terminal device 10, using an advertisement request issued by the terminal device 10. The formats of the advertisements to be delivered to the respective advertisement spots AR, as indicated in the format list FM31 may also be determined by the advertisement delivery apparatus 100, based on the user information of the user using the terminal device 10, the information related to the content CT11, or the information related to the advertisement spots AR.

In the example illustrated in FIG. 10, the advertisement delivery apparatus 100 classifies the advertisement spots AR11 to AR17, for example, into a plurality of groups, based on the formats of the advertisements to be delivered to the respective advertisement spots AR (Step S31). For example, the advertisement delivery apparatus 100 classifies the advertisement spots AR11 to AR17, for example, into three groups corresponding to the three formats of “image and characters”, “video”, and “characters”, as indicated in a classification list CL31 in FIG. 10.

Specifically, the advertisement delivery apparatus 100 classifies the advertisement spots AR11, AR12, AR14, for example, having the “image and characters” format for the advertisement to be delivered, into a group G31. The advertisement delivery apparatus 100 classifies the advertisement spots AR13, AR17, for example, having the “video” format for the advertisement to be delivered, into a group G32. The advertisement delivery apparatus 100 also classifies the advertisement spots AR15, AR16, for example, having the “characters” format for the advertisement to be delivered, into a group G33. The advertisement delivery apparatus 100 then determines the advertisements to be delivered to the advertisement spots AR by holding different auctions for the respective groups G31 to G33, for example. In this manner, the advertisement delivery apparatus 100 can determine the advertisements to be delivered appropriately, by acquiring the advertisements for each of the groups that are based on the format.

5-3. Classification Based on Delivery Time

Content such as the content CT11 illustrated in FIG. 1 include a shown portion being shown on the terminal device 10, and a hidden portion. The content CT11 is displayed in such a manner that the portion being shown on the terminal device 10 can be switched by a user operation. In the content including a shown portion being shown on the terminal device 10 and a hidden portion, the limitation imposed on the time from when an advertisement is requested to when the advertisement to be delivered to be delivered to the advertisement spot AR (hereinafter, also referred to as a “time to be spent before the delivery”) changes depending on the position of the corresponding advertisement spot AR, that is, the position of the advertisement to be delivered. In this manner, the waiting time from when the advertisement is requested to when the advertisement to be delivered is delivered to the advertisement spot AR changes depending on the position of the corresponding advertisement spot AR, that is, the position of the advertisement to be delivered. Therefore, the advertisement delivery apparatus 100 acquires the advertisements from the advertisement providing servers by requesting the advertisements from the advertisement providing servers for each of a plurality of groups of the displayed positions, based on the condition related to the time to be spent before the advertisement is delivered to the terminal device 10.

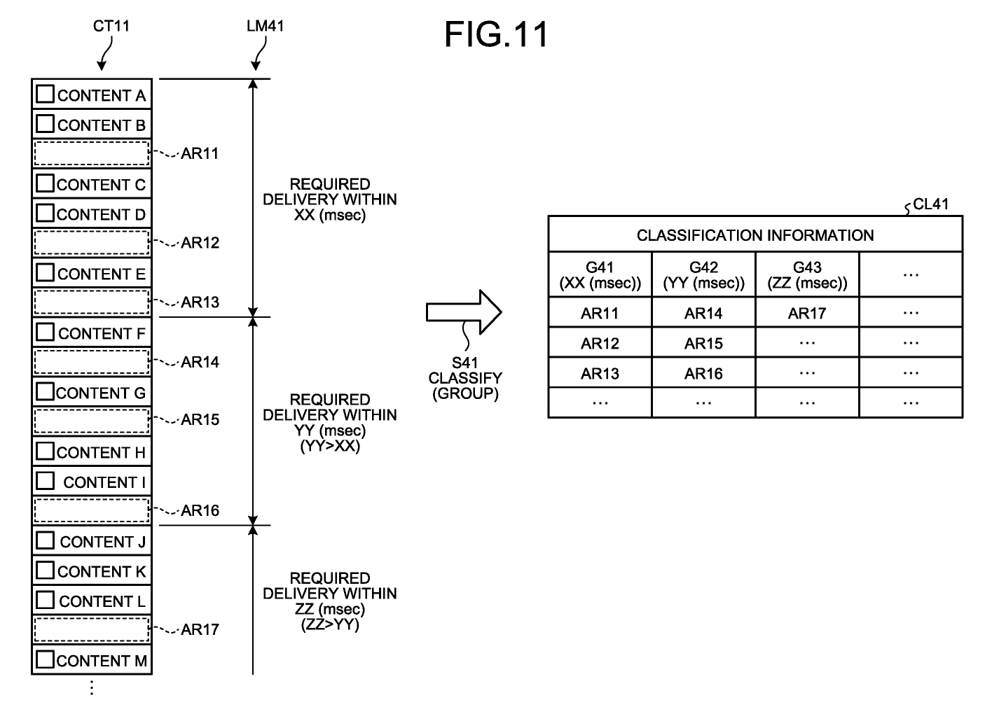

For example, in the content CT11 in FIG. 1, it is preferable for the time to be spent in delivering the advertisement to the advertisement spot AR11 included in the first view to be as short as possible. By contrast, in the content CT11 in FIG. 1, it is permissible for the time to be spent in delivering the advertisement to the advertisement spot AR17, which is positioned in a lower portion, to be longer than the time to be spent in delivering the advertisement to the advertisement spot AR11. Therefore, the advertisement delivery apparatus 100 may classify the advertisement spots AR into a plurality of groups, for example, based on the limitation imposed on the time to be spent in the delivery of the advertisements to the respective advertisement spots AR. This point will now be explained with reference to FIG. 11. The content CT11 in FIG. 11 is the same as the content CT11 in FIG. 1.

It is assumed that, in the example illustrated in FIG. 11, the limitations imposed on the time to be spent in the delivery to the respective advertisement spots AR are established as time limitation intervals LM41. For example, as indicated in the time limitation intervals LM41, it is assumed that the limitation imposed on the time to be spent in the delivery to the advertisement spots AR11 to AR13 is “XX (msec.)”. Furthermore, for example, as indicated in the time limitation intervals LM41, it is assumed that the limitation imposed on the time to be spent in the delivery to the advertisement spots AR14 to AR16 is “YY (msec.)” that is longer than “XX”. Furthermore, for example, as indicated in the time limitation intervals LM41, it is assumed that the limitation imposed on the time to be spent in the delivery to the advertisement spots AR including and positioned below the advertisement spot AR17 is “ZZ (msec.)” that is longer than “YY”.

The limitations imposed on the time to be spent in the delivery to the respective advertisement spots AR, indicated as the time limitation intervals LM41, may be received from the terminal device 10, in an advertisement request issued by the terminal device 10. The limitations imposed on the time to be spent in the delivery to the respective advertisement spots AR, indicated as the time limitation intervals LM41, may also be determined by the advertisement delivery apparatus 100 based on the user information of the user using the terminal device 10, the information related to the content CT11, or the information related to the advertisement spot AR.

In the example illustrated in FIG. 11, the advertisement delivery apparatus 100 classifies the advertisement spots AR11 to AR17, for example, into a plurality of groups based on the limitations imposed on the time to be spent in the delivery to the respective advertisement spots AR (Step S41). For example, the advertisement delivery apparatus 100 classifies the advertisement spots AR11 to AR17, for example, into three groups, correspondingly to the three limitations imposed on the time to be spent in the delivery, “XX”, “YY”, and “ZZ”, as indicated in a classification list CL41 in FIG. 11

Specifically, the advertisement delivery apparatus 100 classifies the advertisement spots AR11 to AR13 specified with “XX” as the limitation imposed on the time to be spent in the delivery, into a group G41. The advertisement delivery apparatus 100 also classifies the advertisement spot AR14 to AR16 having “YY” as the limitation imposed on the time to be spent in the delivery, into a group G42. The advertisement delivery apparatus 100 also classifies the advertisement spots AR including and positioned below the advertisement spot AR17 having “ZZ” as the limitation imposed on the time to be spent in the delivery, into a group G43. The advertisement delivery apparatus 100 then determines the advertisements to be delivered to the advertisement spots AR by holding different auctions for the respective groups G41 to G43, for example.

For example, the advertisement delivery apparatus 100 determines the advertisements to be delivered to the advertisement spots AR11 to AR13 by holding an auction only for the group G41, and delivers the advertisements. In this manner, the advertisement delivery apparatus 100 can deliver the advertisements to be delivered to the advertisement spots AR for which a tighter limitation is imposed on the time to be spent in the delivery, that is, having a shorter time limit before the advertisement is delivered, at a higher priority. The advertisement delivery apparatus 100 then holds auctions for the group G42 and the group G43, respectively, and determines the advertisements to be delivered to the advertisement spots AR included in the group G42 and the group G43. In the manner described above, the advertisement delivery apparatus 100 can determine the advertisements to be delivered appropriately, by acquiring the advertisements for each of the groups that are based on the limitations imposed on the time to be spent in the delivery.

5-4. Classification for Collecting Records of Successful Bids

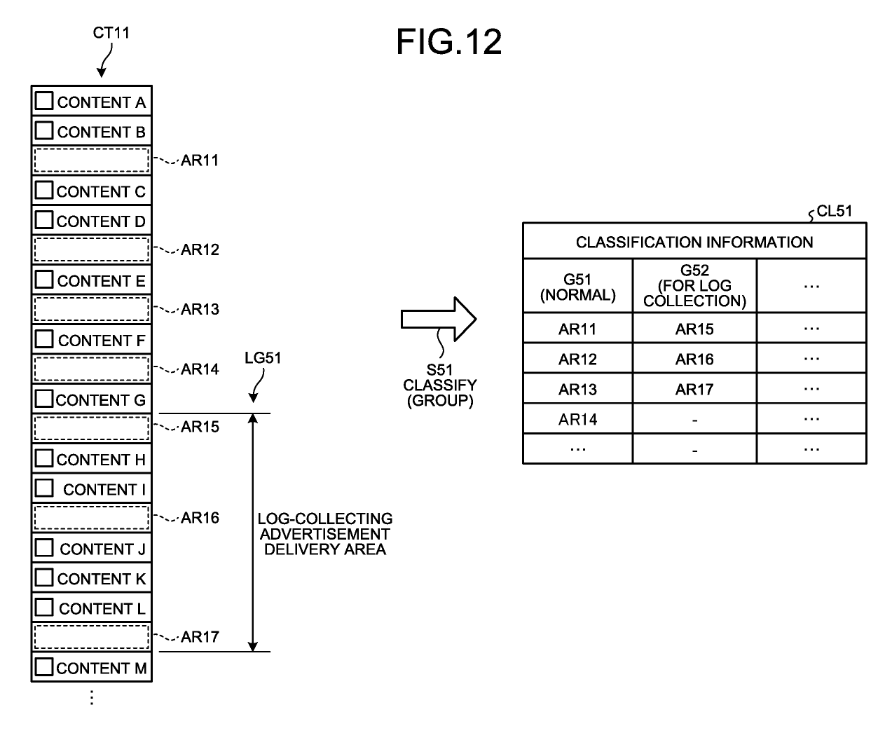

In the advertisement delivery process, for example, when the advertisement delivery apparatus 100 is configured to determine the advertisements to be delivered to the respective advertisement spots AR based on the information related to the past records of successful bids, it is sometimes less likely for the advertisement delivery apparatus 100 to determine the advertisements having only a few records of successful bids or new advertisements, that is, the advertisements having no record of successful bids, as the advertisement to be delivered. Therefore, the advertisement delivery apparatus 100 may classify the advertisement spots AR into a plurality of groups, by classifying some of the advertisement spots AR as the advertisement spots AR for collecting a log, for example. This point will now be explained with reference to FIG. 12. The content CT 11 in FIG. 12 is the same as the content CT11 in FIG. 1.

In the example illustrated in FIG. 12, it is assumed that a predetermined section is established as an area LG51 to which the advertisements are delivered to collect a log. For example, it is assumed that this log-collecting advertisement delivery area LG51 represents a section between the advertisement spot AR15 and the advertisement spot AR17. The log-collecting advertisement delivery area LG51 may be determined by the advertisement delivery apparatus 100 based on the user information of the user using the terminal device 10, the information related to the content CT11, or the information related to the advertisement spots AR.

In the example illustrated in FIG. 12, the advertisement delivery apparatus 100 classifies the advertisement spots AR11 to AR17, for example, into a plurality of groups, based on whether the advertisement spots are positioned within the log-collecting advertisement delivery area LG51 (Step S51). For example, as indicated in a classification list CL51 in FIG. 12, the advertisement delivery apparatus 100 classifies the advertisement spots AR11 to AR17, for example, into two groups, correspondingly to the two intervals, one group of which is “normal” for the advertisement spots that are not positioned within the log-collecting advertisement delivery area LG51, and the other group of which is “log collection” including the advertisement spots that are positioned within the log-collecting advertisement delivery area LG51.

Specifically, the advertisement delivery apparatus 100 classifies the advertisement spot AR11 to AR14, for example, that are not positioned within the log-collecting advertisement delivery area LG51 into a group G51. The advertisement delivery apparatus 100 also classifies AR15 to AR17 that are positioned within the log-collecting advertisement delivery area LG51 into a group G52. The advertisement delivery apparatus 100 then determines the advertisements to be delivered to the respective advertisement spots AR by holding different auctions for the respective groups G51, G52, for example. The advertisement delivery apparatus 100 may also determine the advertisements to be delivered to the respective advertisement spots AR included in the group G52, for example, using any scheme other than auctioning. In this manner, the advertisement delivery apparatus 100 can determine the advertisements to be delivered appropriately, by acquiring the advertisements for each of the groups of log-collecting advertisement spots AR, and of the other advertisement spots AR.

5-5. Determining Advertisement Based on Receiver of Advertisement

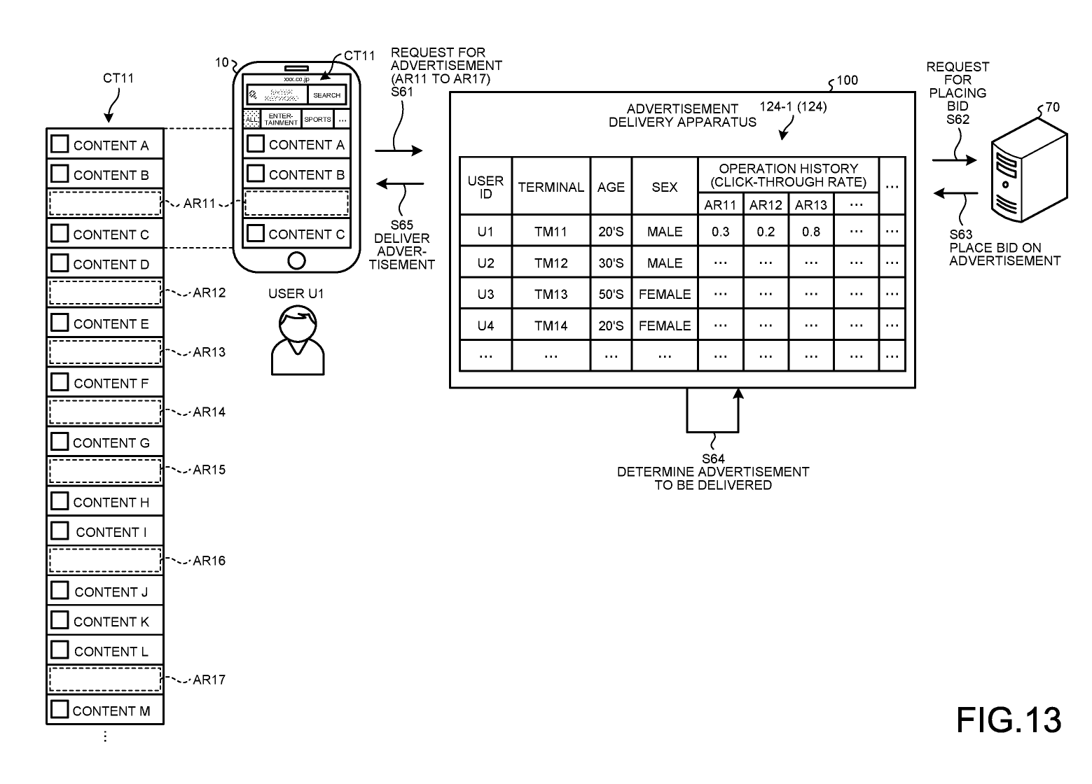

For example, the advertisement delivery apparatus 100 may determine the advertisements to be delivered based on the receiver of the advertisement. For example, the advertisement delivery apparatus 100 may determine the advertisements to be delivered based on the user information of the user using the terminal device 10 by which the advertisements are requested. For example, the advertisement delivery apparatus 100 may determine the advertisements to be delivered, based on the behavior information of the user using the terminal device 10 by which the advertisements are requested. This point will now be explained with reference to FIG. 13. In the example illustrated in FIG. 13, it is assumed that a user information storage unit 124-1 stores therein the history of user operations, as the behavior information of the user using the terminal device 10. Specifically, the user information storage unit 124-1 illustrated in FIG. 13 stores therein the probability at which the advertisement displayed in each of the advertisement spots AR is selected by the user (click-through rate). In the example illustrated in FIG. 13, it is also assumed that the terminal device 10 has received the content CT11 from the content delivery apparatus 50. The content CT11 in FIG. 13 is the same as the content CT11 in FIG. 1.

To begin with, the terminal device 10 transmits an advertisement request for the advertisements to be displayed in the advertisement spots AR11 to AR17 included in the received content CT11 to the advertisement delivery apparatus 100 (Step S61).

The advertisement delivery apparatus 100 having acquired the advertisement request from the terminal device 10 classifies the advertisement spots AR corresponding to the advertisement request into a plurality of groups based on a predetermined condition, and requests the corresponding DSP devices 70 to place their bid on their advertisements that will be the candidates for the advertisements to be delivered to the respective advertisement spots AR belonging to each of such groups (Step S62).

Each of the DSP devices 70 having received the bid request at Step S62 then places a bid on the advertisement to the advertisement delivery apparatus 100 (Step S63). The advertisement delivery apparatus 100 having acquired the bid advertisements from the DSP devices 70 determines the advertisement to be delivered for each of the advertisement spots AR (Step S64).

In the example illustrated in FIG. 13, the advertisement to be delivered to each of the advertisement spots AR is determined based on the user operation history stored in the user information storage unit 124-1. For example, in the example illustrated in FIG. 13, the user U1 exhibits a higher click-through rate on the advertisement displayed in the advertisement spot AR13, compared with that displayed in the advertisement spot AR11 or in the advertisement spot AR12, for example. Therefore, the advertisement delivery apparatus 100 determines, for the user U1, the advertisement to be delivered to the advertisement spot AR13 at a higher priority than those to be delivered to the other advertisement spots AR. The advertisement delivery apparatus 100 may also determine the advertisement to be delivered to each of the advertisement spots AR for the user U1 in such a manner that the expected revenue of the advertisement to be delivered to the advertisement spot AR13 is increased. The advertisement delivery apparatus 100 also may determine the advertisement to be delivered to each of the advertisement spots AR based on the operation history of the user U1 stored in the user information storage unit 124-1, in such a manner that the expected revenue of the entire advertisements to be delivered to the advertisement spots AR is increased.

The advertisement delivery apparatus 100 then delivers the advertisements to be delivered determined at Step S64 to the terminal device 10 (Step S65). In the manner described above, the advertisement delivery apparatus 100 can determine advertisements that are suitable for each user as the advertisements to be delivered, by determining the advertisement to be delivered based on the user information of such a user. In this manner, the advertisement delivery apparatus 100 can determine the advertisements to be delivered appropriately. Used in the explanation above is an example in which the behavior information of each user is used in determining the advertisements to be delivered, but the advertisement delivery apparatus 100 may classify the advertisement spots AR into a plurality of groups based on the user operation history stored in the user information storage unit 124-1. For example, the advertisement delivery apparatus 100 may classify the advertisement spots AR into a plurality of groups that include a group only including the advertisement spot AR13 in which the user U1 exhibits a higher click-through rate. In this manner, the advertisement delivery apparatus 100 can determine the advertisements to be delivered based on the behavior information of the user, and therefore, the advertisement delivery apparatus 100 can determine the advertisements to be delivered appropriately.

5-6. Determining Format Based on Receiver of Advertisement

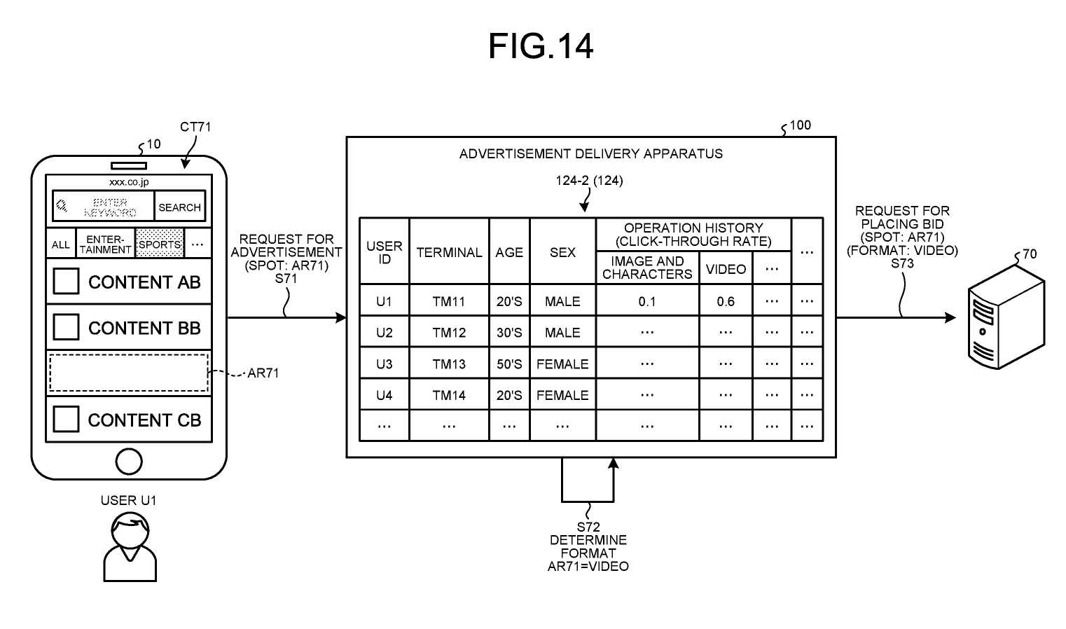

For example, the advertisement delivery apparatus 100 may determine the format of the advertisement to be delivered, based on the receiver of the advertisement. For example, the advertisement delivery apparatus 100 may determine the format of the advertisement to be delivered based on the user information of the user using the terminal device 10 by which the advertisements are requested. For example, the advertisement delivery apparatus 100 may determine the format of the advertisement to be delivered based on the behavior information of the user using the terminal device 10 by which the advertisements are requested. This point will now be explained with reference to FIG. 14. In the example illustrated in FIG. 14, a user information storage unit 124-2 stores therein the user operation history, as the behavior information of the user using the terminal device 10. Specifically, it is assumed herein that the user information storage unit 124-2 illustrated in FIG. 14 stores therein the probability at which the advertisements having each format are selected by the user (click-through rate). In the example illustrated in FIG. 14, it is assumed that the terminal device 10 has received content CT71 including the advertisement spot AR71 from the content delivery apparatus 50.

To begin with, the terminal device 10 transmits an advertisement request for the advertisement to be displayed in the advertisement spot AR71 included in the received content CT71 to the advertisement delivery apparatus 100 (Step S71).

In the example illustrated in FIG. 14, the format of the advertisement to be delivered to the advertisement spot AR71 is determined based on the user operation history stored in the user information storage unit 124-2 (Step S72). For example, in the example illustrated in FIG. 14, the user U1 exhibits a higher click-through rate on the advertisements in the “video” format, compared with the advertisements in the “image and characters” format. Therefore, the advertisement delivery apparatus 100 determines, for the user U1, the format of the advertisement to be delivered to the advertisement spot AR71 as “video”.

Once the format of the advertisement to be delivered to the advertisement spot AR71 is determined as video, the advertisement delivery apparatus 100 requests the DSP devices 70 to place a bid on the advertisement (Step S73). For example, the advertisement delivery apparatus 100 requests the DSP devices 70 permitted to receive a bid request for an advertisement in a video format to place a bid on the advertisement in the advertisement spot AR71. The advertisement delivery apparatus 100 then determines the advertisement to be delivered to the advertisement spot AR71 based on the bid advertisements in the video format received from the DSP devices 70, for example. In this manner, because the advertisement delivery apparatus 100 can determine the format of the advertisement to be delivered based on the behavior information of the user, the advertisement delivery apparatus 100 can determine the advertisements to be delivered appropriately. Explained with reference to FIG. 14 is an example in which only the information of the user U1 is used, but information of any other users with the user attributes similar to those of the user U1 may be taken into consideration. For example, the advertisement delivery apparatus 100 classifies the advertisements into a plurality of groups based on a condition related to the user attributes of such users.

5-7. Classification Based on User Operation Tendency

Furthermore, when the content includes a shown portion, which is being shown on the terminal device 10, and a hidden portion, in the same manner as the content CT11 in FIG. 1, the time to be spent before each of such a portion to be shown changes depending on the operation tendency of the user. For example, a user who tends to view the content quickly, or a user who tends to look at the partial content included in the lower portion (hereinafter, referred to as a “quick-tempered user”) require a shorter time for the hidden portion positioned in the lower portion of the content to become shown, compared with general users. Furthermore, for example, a user who tends to view the content slowly, or a user who tends to view the partial content positioned in the upper portion such as that positioned in the first view (hereinafter, referred to as a “slow-going user”) requires a longer time for the hidden portion positioned in the lower portion of the content to become shown, compared with general users.

For example, for a quick-tempered user, because it is highly likely for the advertisement spot AR positioned below the first view to be displayed quickly, it is sometimes preferable to also determine the advertisement to be delivered to the advertisement spot AR other than those in the first view quickly. For example, for a quick-tempered user, it is preferable to determine an advertisement to be delivered to the advertisement spot AR12 that is positioned immediately below the first view of the content CT11, at the same time as when the advertisement to be delivered to the advertisement spot AR11 included in the first view is determined.

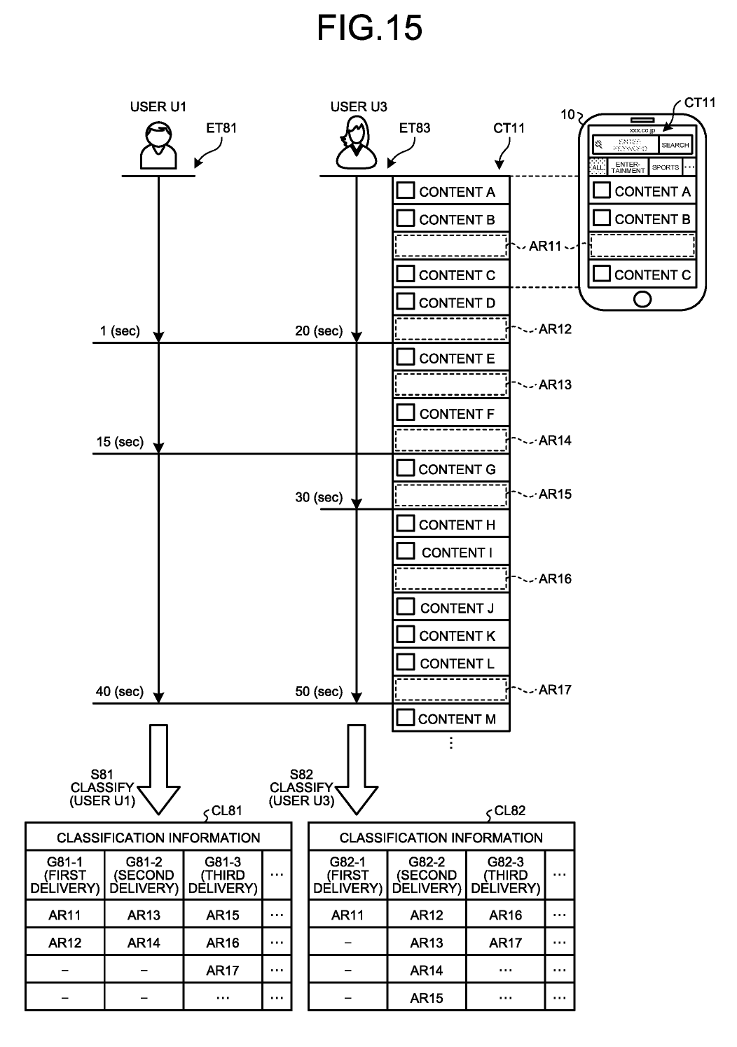

By contrast, for a slow-going user, it is sometimes preferable for only the advertisement to be delivered to the advertisement spot AR included in the first view to be determined quickly. For example, for a slow-going user, it is possible to determine only the advertisement to be delivered to the advertisement spot AR11 included in the first view of the content CT11 immediately after the advertisement request is received, and to determine the advertisements for the other advertisement spots AR sequentially at the timing at which such advertisement spots AR become shown. Therefore, the advertisement delivery apparatus 100 may classify the advertisement spots AR into a plurality of groups based on the operation tendency of the users, for example. This point will now be explained with reference to FIG. 15. Explained now is an example of two users, the user U1 and the user U3, illustrated in FIG. 15. Specifically, the example illustrated in FIG. 15 depicts the user U1 as an example of the quick-tempered user, and the user U3 as an example of the slow-going user. The content CT11 in FIG. 15 is the same as the content CT11 in FIG. 1.

In the example illustrated in FIG. 15, it is assumed that the time estimated to be required for the user U1 who is viewing the content CT11 to display each of the positions (hereinafter, also referred to as an “estimated time”) is as specified in an estimated time table ET81. For example, as indicated in the estimated time table ET81, it is assumed that the estimated time to be spent by the user U1 before the advertisement spot AR12 included in the content CT11 is displayed on the terminal device 10 is “1 sec. (”second(s)“; the same applies hereinafter)”. In the example illustrated in FIG. 15, the estimated time for the content A, the content B, the advertisement spot AR11, and the content C included in the first view of the content CT11 is established as “0 sec.”.

Furthermore, for example, as indicated in the estimated time table ET81, it is assumed that the estimated time to be spent by the user U1 before the advertisement spot AR14 included in the content CT11 is displayed on the terminal device 10 is “15 sec.”. Furthermore, for example, as indicated in the estimated time table ET81, it is assumed that the estimated time to be spent by the user U1 before the advertisement spot AR17 included in the content CT11 is displayed on the terminal device 10 is “40 sec.”.

The number of seconds indicated in the estimated time table ET81 may be an average of the past operation history of the user U1, for example, or may be estimations based on the behavior information of the user U1. For the number of seconds indicated in the estimated time table ET81, information of users who are similar to the user U1 (e.g., the user U2) may also be used.

In the example illustrated in FIG. 15, the advertisement delivery apparatus 100 classifies the advertisement spots AR11 to AR17, for example, included in the content CT11 displayed on the terminal device 10 of the user U1 into a plurality of groups, based on the limitations in the estimated time corresponding to the respective advertisement spots AR (Step S81). For example, the advertisement delivery apparatus 100 classifies the advertisement spots AR11 to AR17, for example, into three groups based on the estimated time corresponding to each of the advertisement spots AR, as indicated in the classification list CL81 in FIG. 15.

Specifically, the advertisement delivery apparatus 100 classifies the advertisement spots AR11, AR12 that are included in the estimated time of “1 sec.” into a first delivery group G81-1. The advertisement delivery apparatus 100 also classifies the advertisement spots AR13, AR14 that are included within the estimated time of “15 sec.” into a second delivery group G81-2. The advertisement delivery apparatus 100 also classifies the advertisement spots AR15 to AR17 that are included within the estimated time of “40 sec.” into a third delivery group G81-3. The advertisement delivery apparatus 100 then determines the advertisements to be delivered to the advertisement spots AR, for each of the first delivery group G81-1, the second delivery group G81-2, and the third delivery group G81-3, by holding different auctions for the respective groups, for example.

For example, the advertisement delivery apparatus 100 then determines the advertisements to be delivered to the advertisement spots AR11, AR12 by holding an auction only for the first delivery group G81-1, and delivers the advertisements. In this manner, the advertisement delivery apparatus 100 can deliver the advertisements that are to be delivered to the advertisement spots AR having short estimated time, that is, the advertisement spots AR that are highly likely to be displayed on the terminal device 10 immediately, at a higher priority. The advertisement delivery apparatus 100 then holds auctions for the second delivery group G81-2 and the third delivery group G81-3, respectively, and determines the advertisements to be delivered to the advertisement spots AR included in the second delivery group G81-2 and the third delivery group G81-3.

By contrast, in the example illustrated in FIG. 15, it is assumed that the time estimated for the user U3 viewing the content CT11 is as specified in an estimated time table ET83. For example, as indicated in the estimated time table ET83, it is assumed that the estimated time to be spent by the user U3 before the advertisement spot AR12 included in the content CT11 is displayed on the terminal device 10 is “20 sec.”. Furthermore, for example, as indicated in the estimated time table ET83, it is assumed that the estimated time to be spent by the user U3 before the advertisement spot AR15 included in the content CT11 is displayed on the terminal device 10 is “30 sec.”. Furthermore, for example, as indicated in the estimated time table ET83, it is assumed that the estimated time to be spent by the user U3 before the advertisement spot AR17 included in the content CT11 is displayed on the terminal device 10 is “50 sec.”.

The number of seconds indicated in the estimated time table ET83 may be an average of the past operation history of the user U3, for example, or may be estimations based on the behavior information of the user U3. For the number of seconds indicated in the estimated time table ET83, information of users who are similar to the user U3 may also be used.

In the example illustrated in FIG. 15, the advertisement delivery apparatus 100 classifies the advertisement spots AR11 to AR17, for example, included in the content CT11 displayed on the terminal device 10 of the user U3 into a plurality of groups, based on the limitations in the estimated time corresponding to the respective advertisement spots AR (Step S82). For example, the advertisement delivery apparatus 100 classifies the advertisement spots AR11 to AR17, for example, into three groups based on the estimated time corresponding to each of the advertisement spots AR, as indicated as in a classification list CL82 in FIG. 15.

Specifically, the advertisement delivery apparatus 100 classifies the advertisement spot AR11 that is included within the estimated time of “0 sec.” into a first delivery group G82-1. The advertisement delivery apparatus 100 also classifies the advertisement spot AR12 to AR15 that are included within the estimated time of “30 sec.” into a second delivery group G82-2. The advertisement delivery apparatus 100 also classifies the advertisement spots AR16, AR17 that are included within the estimated time of “50 sec.” into a third delivery group G82-3. The advertisement delivery apparatus 100 then determines the advertisement to be delivered to the advertisement spot AR, for each of the first delivery group G82-1, the second delivery group G82-2, and the third delivery group G82-3 by holding a different auction for each of such groups, for example. The advertisement delivery apparatus 100 may also classify the advertisement spot AR12 included within the estimated time of “20 sec.”, and the advertisement spots AR13 to AR15 included within the estimated time of “30 sec.” into different groups.

For example, the advertisement delivery apparatus 100 then determines the advertisement to be delivered to the advertisement spot AR11 by holding an auction only for the first delivery group G82-1, and delivers the advertisement. In this manner, the advertisement delivery apparatus 100 can deliver the advertisement that is to be delivered to the advertisement spot AR having an estimated time of “0 sec.”, that is, the advertisement spot AR that is to be displayed immediately on the terminal device 10, at a higher priority. The advertisement delivery apparatus 100 then holds auctions for the second delivery group G82-2 and the third delivery group G82-3, respectively, and determines the advertisements to be delivered to the advertisement spots AR included in the second delivery group G82-2 and the third delivery group G82-3. In the manner described above, the advertisement delivery apparatus 100 can determine the advertisements to be delivered appropriately by acquiring the advertisements for each of a plurality of groups that are based on the estimated time that is to be spent by each user before the advertisement spots AR are displayed, and that changes depending on the user.

6. Modification

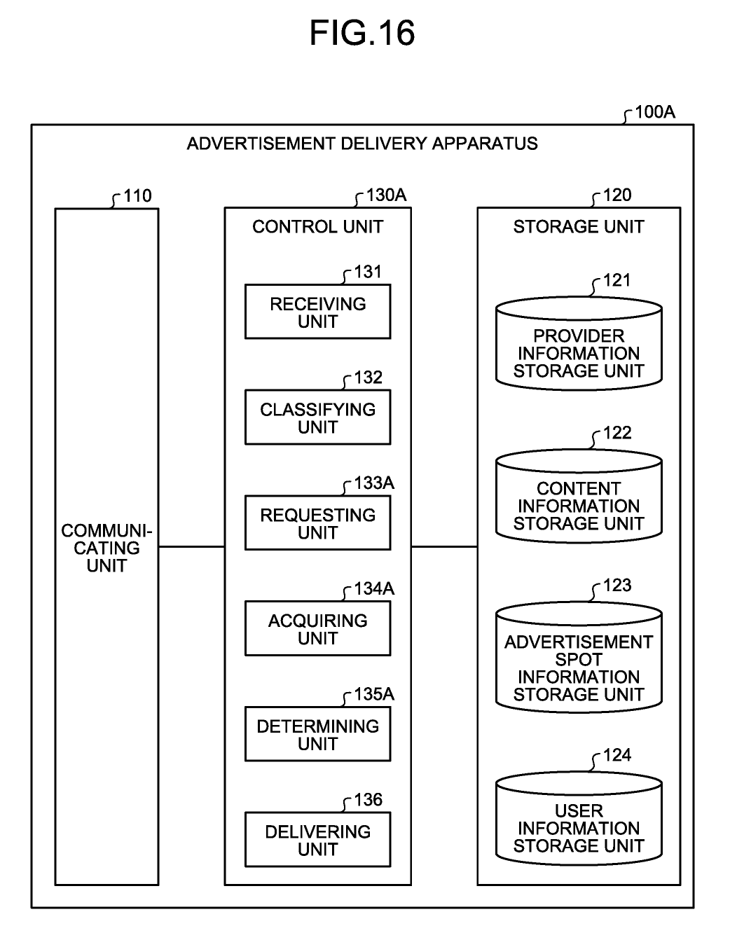

Explained in the embodiment above is an example in which the advertisement delivery apparatus 100 acquires the advertisements from the DSP devices 70. An advertisement delivery apparatus 100A according to a modification may, however, acquire the advertisements from an advertisement providing server other than the DSP devices 70, and deliver the advertisements as the advertisements to be delivered. This point will now be explained based on FIGS. 16 and 17. The elements that are same as those according to the embodiment will be given the same reference numerals, and the explanations thereof will be omitted below.

6-1. About Another Advertisement Providing Server (Advertisement Network Apparatus)

An advertisement delivery process according to the modification is different from that according to the embodiment in that the advertisement delivery apparatus 100A also acquires the advertisements from an advertisement network apparatus 90 (also referred to as an “AN device 90”) that is an advertisement providing server, in addition to the DSP devices 70. The AN device 90 herein means an information processing apparatus performing an advertisement providing process in what is called an advertisement network, and is an apparatus that transmits an advertisement in response to an advertisement request issued by the advertisement delivery apparatus 100A. In other words, the AN device 90 transmits an advertisement having been delivered in response to the advertisement request from the advertisement delivery apparatus 100A to the advertisement delivery apparatus 100A. The advertisement delivery apparatus 100A also delivers the advertisement received from the AN device 90 as the advertisement to be delivered. An administrator or the like of the AN device 90 pays for the expenses accrued for delivering advertisements to an administrator or the like of the advertisement delivery apparatus 100A at a predetermined timing. In other words, the amount billed for the advertisements acquired from the AN device 90 is finalized after such advertisements are delivered. For example, when an advertisement is acquired from the AN device 90, the advertisement delivery apparatus 100A can estimate the expected revenue or the like of the advertisement acquired from the AN device 90 based on the billing information representing the amount billed to the AN device 90 before such advertisement is acquired.

6-2. Configuration of Advertisement Distributing Apparatus

A configuration of the advertisement delivery apparatus 100A according to the modification will now be explained with reference to FIG. 16. FIG. 16 is a schematic illustrating an exemplary configuration of the advertisement delivery apparatus 100A according to the modification. As illustrated in FIG. 16, the advertisement delivery apparatus 100A includes the communicating unit 110, the storage unit 120, and a control unit 130A. The provider information storage unit 121 included in the storage unit 120 according to the modification may store therein information related to the AN device 90 as the provider information.

Control Unit 130A

Returning to the explanation of FIG. 16, the control unit 130A is a controller, and is implemented by causing a CPU or an MPU, for example, to execute various computer programs (corresponding to an example of an advertisement delivery program) stored in the storage device that is provided internally to the advertisement delivery apparatus 100A, using the RAM as a working area. The control unit 130A is a controller, and is implemented as an integrated circuit such as an ASIC or an FPGA, for example.

As illustrated in FIG. 16, the control unit 130A includes the receiving unit 131, the classifying unit 132, a requesting unit 133A, an acquiring unit 134A, a determining unit 135A, and the delivering unit 136, and implements or executes the functions and actions of the advertisement delivery process explained below. The internal configuration of the control unit 130A is not limited to the configuration illustrated in FIG. 16, and may be any other configuration as long as such a configuration performs the advertisement delivery process described later.

Requesting Unit 133A

The requesting unit 133A requests some advertisements from the AN device 90. For example, when the bid advertisements from the DSP devices 70 do not satisfy a predetermined condition, the requesting unit 133A requests the advertisements from the AN device 90. For example, when the expected revenues of the bid advertisements from the DSP devices 70 are less than a predetermined threshold, the requesting unit 133A requests the advertisements from the AN device 90. The requesting unit 133A also performs the same process as that performed by the requesting unit 133.

Acquiring Unit 134A

For example, the acquiring unit 134A acquires the advertisements belonging to one of a plurality of groups from the advertisement providing server by requesting the advertisements from the advertisement providing server through auctioning, and acquires the advertisements belonging to the other groups using a scheme other than auctioning. The acquiring unit 134A acquires a first advertisement from a first advertisement providing server (corresponding to the DSP device 70 in FIG. 17; the same applies in the following) by issuing a first request that is an advertisement request addressed to the first advertisement providing server, and acquires a second advertisement from a second advertisement providing server (corresponding to the AN device 90 in FIG. 17; the same applies in the following) by issuing a second request that is an advertisement request addressed to the second advertisement providing server, subsequently to the first request, and that changes depending on the first advertisement. For example, the acquiring unit 134A acquires the first advertisement from the DSP device 70 using the first request that is an advertisement request addressed to the DSP device 70, and acquires the second advertisement from the AN device 90 using the second request that is subsequent to the first request and is an advertisement request addressed to the AN device 90. For example, the acquiring unit 134A acquires the first advertisement from the first advertisement providing server upon receiving an request for advertisements using an auction, or upon receiving a first request that is an advertisement request from the first advertisement providing server providing advertisements the delivery of which is optional, and acquires the second advertisement from the second advertisement providing server providing advertisements the delivery of which is mandatory, using the second request that is an advertisement request subsequent to the first request and addressed to the second advertisement providing server.

Determining Unit 135A

The determining unit 135A determines the advertisement acquired from the second advertisement providing server as the advertisement to be delivered. For example, if the bid advertisements of the DSP devices 70 do not satisfy a predetermined condition, the determining unit 135A determines the advertisement acquired from the AN device 90 as the advertisement to be delivered. For example, if the expected revenues of the bid advertisements of the DSP devices 70 are less than a predetermined threshold, the determining unit 135A determines the advertisement acquired from the AN device 90 as the advertisement to be delivered. The determining unit 135A also performs the same process as that performed by the determining unit 135.

6-3. Sequence of Process

The sequence of an advertisement displaying process performed in a delivery system 1A will now be explained with reference to FIG. 17. FIG. 17 is a sequence chart illustrating an example of an advertisement delivery process according to the modification. Illustrated in the sequence chart in FIG. 17 is a process related to the terminal device 10, the content delivery apparatus 50, the advertisement delivery apparatus 100A, the DSP devices 70, and the AN device 90.

As illustrated in FIG. 17, the terminal device 10 transmits a content delivery request to the content delivery apparatus 50 (Step S91). The content delivery apparatus 50 having received the delivery request from the terminal device 10 delivers the content to the terminal device 10 (Step S92).

The terminal device 10 having received the content transmits a request for the advertisement to be displayed in the advertisement spot included in the received content to the advertisement delivery apparatus 100A (Step S93). Alternatively, the content delivery apparatus 50 may transmit a request for the advertisement to be displayed in the advertisement spot to the advertisement delivery apparatus 100A. The advertisement delivery apparatus 100A having acquired the advertisement request from the terminal device 10 requests the DSP device 70 to place a bid on the advertisement (Step S94). The DSP device 70 having received the bid request for the advertisement from the advertisement delivery apparatus 100A transmits the information related to the bid advertisement to the advertisement delivery apparatus 100A (Step S95).

The advertisement delivery apparatus 100A having acquired the bid advertisement from the DSP device 70 determines whether the bid advertisement satisfies the condition (Step S96). For example, if the bid advertisement acquired at Step S96 satisfies the condition (Yes at Step S96), the advertisement delivery apparatus 100A determines the advertisement to be delivered, based on the bid advertisement (Step S97).

If the bid advertisement acquired from the DSP device 70 does not satisfy condition (No at Step S96), the advertisement delivery apparatus 100A requests the advertisement from the AN device 90 (Step S96-1). The advertisement delivery apparatus 100A then determines the advertisement to be delivered based on the bid advertisement and the advertisement acquired from the AN device 90 (Step S97).

The advertisement delivery apparatus 100A then delivers the advertisement determined at Step S97 to the terminal device 10 (Step S98). The terminal device 10 having received the advertisement from the advertisement delivery apparatus 100A displays the advertisement (Step S99).

7. Delivery of Advertisement by Advertisement Distributing Apparatus

Explained above is an example in which the advertisement delivery apparatus 100, 100A determines the advertisements acquired from the advertisement providing servers such as the DSP devices 70 and the AN device 90 as the advertisements to be delivered. The advertisement delivery apparatus 100, 100A may, however, determine an advertisement that is locally owned by the advertisement delivery apparatus 100, 100A as the advertisement to be delivered. For example, to enable the advertisement delivery apparatus 100, 100A to determine the advertisement locally owned by the advertisement delivery apparatus 100, 100A as the advertisement to be delivered, the advertisement delivery apparatus 100, 100A may be provided with an advertisement information storage unit (not illustrated) storing therein information related to the advertisement, and determine the advertisement acquired from the advertisement information storage unit as the advertisement to be delivered.

For example, if the expected revenue of the advertisement locally owned by the advertisement delivery apparatus 100, 100A is higher than the expected revenue of the advertisements acquired from the DSP devices 70, the advertisement delivery apparatus 100, 100A may determine the advertisement locally owned by the advertisement delivery apparatus 100, 100A as the advertisement to be delivered. Furthermore, the advertisement delivery apparatus 100, 100A may also determine one of combinations of advertisements acquired from the DSP devices 70 and advertisements locally owned by the advertisement delivery apparatus 100, 100A as the advertisements to be delivered, provided that the such combination results in the highest entire expected revenue. The advertisement delivery apparatus 100, 100A may determine the advertisement locally owned by the advertisement delivery apparatus 100, 100A as the advertisement to be delivered, if there is no bid for the advertisement from the DSP devices 70 even after a predetermined waiting time elapses from when the bid request for the advertisement is sent to the DSP device 70.

Furthermore, for example, if the advertisements acquired from the DSP device 70 and the advertisements locally owned by the advertisement delivery apparatus 100, 100A do not satisfy the condition for the advertisement to be delivered, the advertisement delivery apparatus 100, 100A may acquire the advertisement from the AN device 90, and deliver the advertisement. For example, if the expected revenue of the advertisement acquired from the DSP device 70 or the expected revenue of the advertisement locally owned by the advertisement delivery apparatus 100, 100A are less than a predetermined threshold, the advertisement delivery apparatus 100, 100A may acquire the advertisement from the AN device 90, and deliver the advertisement. In the manner described above, the advertisement delivery apparatus 100, 100A may determine the advertisement to be delivered from the advertisements acquired from the advertisement providing servers, such as the DSP devices 70 and the AN device 90, and the advertisement locally owned by the advertisement delivery apparatus 100, 100A, based on various conditions.

8. Effects

As described above, each of the advertisement delivery apparatus 100 according to the embodiment and the advertisement delivery apparatus 100A according to the modification includes the receiving unit 131, the classifying unit 132, and the determining unit 135, 135A. The receiving unit 131 receives a delivery request for a plurality of advertisements (the “advertisement spots AR” in the embodiment and the modification; the same applies below) that are to be delivered to the terminal device 10. The classifying unit 132 classifies a plurality of advertisements for which a delivery request is received by the receiving unit 131 into a plurality of groups, based on a predetermined condition. The determining unit 135, 135A determines the advertisement to be delivered, for each of the groups classified by the classifying unit 132.

In this manner, the advertisement delivery apparatus 100 according to the embodiment and the advertisement delivery apparatus 100A according to the modification can determine the advertisements to be delivered appropriately, by classifying a plurality of advertisements into a plurality of groups based on a predetermined condition, and determining the advertisements to be delivered for each of the classified groups.

Furthermore, in the advertisement delivery apparatus 100 according to the embodiment and the advertisement delivery apparatus 100A according to the modification, the classifying unit 132 classifies the advertisements into a plurality of groups based on a time-related condition assigned to each of the advertisements.

In this manner, the advertisement delivery apparatus 100 according to the embodiment and the advertisement delivery apparatus 100A according to the modification can determine the advertisements to be delivered appropriately, by classifying a plurality of advertisements into a plurality of groups based on the time-related condition assigned to the advertisements, and determining the advertisement to be delivered for each of the classified groups.

Furthermore, in the advertisement delivery apparatus 100 according to the embodiment and the advertisement delivery apparatus 100A according to the modification, the classifying unit 132 classifies the advertisements into a plurality of groups based on a time-related condition that is assigned to the advertisements depending on the positions where the respective advertisements are displayed.

In this manner, the advertisement delivery apparatus 100 according to the embodiment and the advertisement delivery apparatus 100A according to the modification can determine the advertisements to be delivered appropriately, by classifying a plurality of advertisements into a plurality of groups based on the time-related condition assigned to the advertisements based on the positions where the respective advertisements are displayed, and determining the advertisement to be delivered for each of the classified groups.

Furthermore, in the advertisement delivery apparatus 100 according to the embodiment and the advertisement delivery apparatus 100A according to the modification, the classifying unit 132 classifies the advertisements into a plurality of groups, based on a time-related condition that is related to the time to be spent before each of the advertisements is displayed on the terminal device 10.

In this manner, the advertisement delivery apparatus 100 according to the embodiment and the advertisement delivery apparatus 100A according to the modification can determine the advertisements to be delivered appropriately, by classifying a plurality of advertisements into a plurality of groups based on the time-related condition that is related to the time to be spent before each of the advertisements is displayed on the terminal device 10, and by determining the advertisement to be delivered for each of the classified groups.

Furthermore, in the advertisement delivery apparatus 100 according to the embodiment and the advertisement delivery apparatus 100A according to the modification, the classifying unit 132 classifies the advertisements into a plurality of groups based on a condition related to the expected revenue from the delivery of the advertisement, in response to a delivery request.

In this manner, the advertisement delivery apparatus 100 according to the embodiment and the advertisement delivery apparatus 100A according to the modification can determine the advertisements to be delivered appropriately, by classifying a plurality of advertisements into a plurality of groups based on a condition related to the expected revenue of the delivery of the advertisement in response to a delivery request, and determining the advertisement to be delivered for each of the classified groups.

Furthermore, in the advertisement delivery apparatus 100 according to the embodiment and the advertisement delivery apparatus 100A according to the modification, the classifying unit 132 classifies the advertisements into a plurality of groups, based on a condition related to the user using the terminal device 10.

In this manner, the advertisement delivery apparatus 100 according to the embodiment and the advertisement delivery apparatus 100A according to the modification can determine the advertisements to be delivered appropriately, by classifying a plurality of advertisements into a plurality of groups based on the condition related to the user using the terminal device 10, and determining the advertisement to be delivered for each of the classified groups.

Furthermore, in the advertisement delivery apparatus 100 according to the embodiment and the advertisement delivery apparatus 100A according to the modification, the classifying unit 132 classifies the advertisements into a plurality of groups based on a condition related to the history of behavior of the user.

In this manner, the advertisement delivery apparatus 100 according to the embodiment and the advertisement delivery apparatus 100A according to the modification can determine the advertisements to be delivered appropriately, by classifying a plurality of advertisements into a plurality of groups based on the condition related to the history of behavior of the user, and determining the advertisement to be delivered for each of the classified groups.

Furthermore, in the advertisement delivery apparatus 100 according to the embodiment and the advertisement delivery apparatus 100A according to the modification, the classifying unit 132 classifies the advertisements into a plurality of groups based on a condition related to user attributes of the user.

In this manner, the advertisement delivery apparatus 100 according to the embodiment and the advertisement delivery apparatus 100A according to the modification can determine the advertisements to be delivered appropriately, by classifying a plurality of advertisements into a plurality of groups based on a condition related to the user attributes of the user, and determining the advertisement to be delivered for each of the classified groups.

Furthermore, in the advertisement delivery apparatus 100 according to the embodiment and the advertisement delivery apparatus 100A according to the modification, the classifying unit 132 classifies the advertisements into a plurality of groups based on a condition related to the positions where the respective advertisements are displayed.

In this manner, the advertisement delivery apparatus 100 according to the embodiment and the advertisement delivery apparatus 100A according to the modification can determine the advertisements to be delivered appropriately, by classifying a plurality of advertisements into a plurality of groups based on the condition related to the positions where the advertisements are displayed, and determining the advertisement to be delivered for each of the classified groups.

Furthermore, in the advertisement delivery apparatus 100 according to the embodiment and the advertisement delivery apparatus 100A according to the modification, the classifying unit 132 classifies the advertisements into a plurality of groups based on a condition related to the format in which the respective advertisements are displayed.

In this manner, the advertisement delivery apparatus 100 according to the embodiment and the advertisement delivery apparatus 100A according to the modification can determine the advertisements to be delivered appropriately, by classifying the advertisements into a plurality of groups based on the condition related to the format in which the respective advertisements are displayed, and determining the advertisement to be delivered for each of the classified groups.

Furthermore, the advertisement delivery apparatus 100 according to the embodiment and the advertisement delivery apparatus 100A according to the modification include the acquiring unit 134, 134A. The acquiring unit 134, 134A acquires the advertisements from the advertisement providing servers (“the DSP devices 70” and “the AN device 90” in the embodiment and the modification; the same applies below) for each of a plurality of groups, by requesting the advertisements from the advertisement providing servers.

In this manner, the advertisement delivery apparatus 100 according to the embodiment and the advertisement delivery apparatus 100A according to the modification can determine the advertisements to be delivered appropriately, by requesting the advertisements from the advertisement providing servers, and acquiring the advertisements from the advertisement providing servers, for each of a plurality of groups.

Furthermore, the advertisement delivery apparatus 100 according to the embodiment and the advertisement delivery apparatus 100A according to the modification include the acquiring unit 134, 134A. Among a plurality of groups of advertisements, the acquiring unit 134, 134A acquires the advertisement belonging to one of the groups from the advertisement providing server by requesting the advertisement from the advertisement providing server through auctioning, and acquires the advertisements of the other groups using a scheme other than auctioning.

In this manner, the advertisement delivery apparatus 100, 100A can determine the advertisements to be delivered appropriately, because the advertisement delivery apparatus 100 according to the embodiment and the advertisement delivery apparatus 100A according to the modification can acquire advertisements using a different approach for each of a plurality of groups.

9. Hardware Configuration

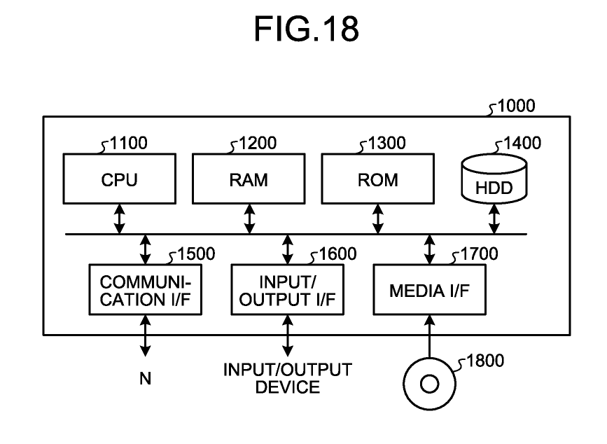

The advertisement delivery apparatus 100 according to the embodiment and the advertisement delivery apparatus 100A according to the modification described above are implemented as a computer 1000 illustrated in FIG. 18, for example. FIG. 18 is a schematic illustrating a hardware configuration of an example of a computer for implementing the functions of the advertisement delivery apparatus. The computer 1000 includes a CPU 1100, a RAM 1200, a read-only memory (ROM) 1300, a hard-disk drive (HDD) 1400, a communication interface (I/F) 1500, an input/output I/F 1600, and a media I/F 1700.

The CPU 1100 operates based on a computer program stored in the ROM 1300 or the HDD 1400, and controls each unit. The ROM 1300 stores therein a boot program executed by the CPU 1100 when the computer 1000 is started, and computer programs that are dependent on the hardware of the computer 1000.

The HDD 1400 stores therein the computer programs executed by the CPU 1100, and data used by the computer programs, for example. The communication interface 1500 receives data from other devices over a network N, and sends the received data to the CPU 1100, and transmits data generated by the CPU 1100 to the other devices over the network N.

The CPU 1100 controls output devices such as a display and a printer, and input devices such as a keyboard and a mouse via the input/output IF 1600. The CPU 1100 acquires data from the input devices via the input/output IF 1600. The CPU 1100 outputs the generated data to the output devices via the input/output IF 1600.

The media interface 1700 reads a computer program or data stored in a recording medium 1800, and provides the computer program or the data to the CPU 1100 via the RAM 1200. The CPU 1100 loads the computer program from the recording medium 1800 onto the RAM 1200 via the media interface 1700, and executes the loaded computer program. Examples of the recording medium 1800 include optical recording media such as a digital versatile disc (DVD) and a phase change rewritable disk (PD), magneto-optical recording media such as a magneto-optical disc (MO), a tape medium, a magnetic recording medium, and a semi-conductor memory.

For example, when the computer 1000 functions as the advertisement delivery apparatus 100, 100A, the CPU 1100 in the computer 1000 implements the functions of the control unit 130, 130A by executing the computer programs loaded on the RAM 1200. While the CPU 1100 in the computer 1000 is configured to read such computer programs from the recording medium 1800 and to execute the computer programs, the CPU 1100 may also acquire the computer programs from another device over the network N, as another example.

Some of the embodiments and modifications according to the present application are explained above in detail with reference to the drawings, but these embodiment and modification are provided merely as examples, and the present invention may be embodied in different modes, including those described in the section of Detailed Description of the Preferred Embodiments, applied with various modifications and improvements based on the knowledge of those skilled in the art.

10. Others

The processes explained to be executed automatically in the embodiment and modification may also be partially or entirely executed manually, and the processes explained to be executed manually may be partially or entirely executed automatically using a known method. In addition, the sequence of the processes, specific names, various types of data, and information including parameters mentioned herein and in the drawings may be modified in any way, unless specified otherwise. For example, various types of information illustrated in the drawings are not limited to those illustrated in the drawings.

Furthermore, the elements included in each of the apparatuses illustrated in the drawings are merely functional and conceptual representations, and do not necessarily need to be physically configured as illustrated in the drawings. In other words, the specific ways in which each of the apparatuses is distributed or integrated are not limited to those illustrated, and the apparatuses may be partially or entirely distributed or integrated functionally or physically into any units, depending on various loads and utilizations.

Furthermore, the embodiment and the modifications described above may be combined as appropriate, within the scope in which the processes do not contradict with one another.

The term “unit (section, module)” mentioned herein may be replaced by a term such as “means” or “circuit”. For example, the receiving unit can also be said to be receiving means or receiving circuit.

According to one aspect of the embodiment, advertisements to be delivered can be determined appropriately.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An advertisement delivery apparatus comprising:
a receiving unit that receives a delivery request for a plurality of advertisements to be delivered to a terminal device;
a classifying unit that classifies the advertisements for which the delivery request is received by the receiving unit into a plurality of groups based on a predetermined condition; and
a determining unit that determines the advertisements to be delivered, for each of the groups classified by the classifying unit.

2. The advertisement delivery apparatus according to claim 1, wherein the classifying unit classifies the advertisements into a plurality of groups based on a time-related condition assigned to each of the advertisements.

3. The advertisement delivery apparatus according to claim 2, wherein the classifying unit classifies the advertisements into a plurality of groups based on a time-related condition assigned to each of the advertisements based on a position at which the corresponding advertisement is displayed.

4. The advertisement delivery apparatus according to claim 2, wherein the classifying unit classifies the advertisements into a plurality of groups based on a condition related to time to be spent before each of the advertisements is displayed on the terminal device.

5. The advertisement delivery apparatus according to claim 1, wherein the classifying unit classifies the advertisements into a plurality of groups based on a condition related to an expected revenue resultant of delivering each of the advertisements, in response to the delivery request.

6. The advertisement delivery apparatus according to claim 1, wherein the classifying unit classifies the advertisements into a plurality of groups based on a condition related to a user using the terminal device.

7. The advertisement delivery apparatus according to claim 6, wherein the classifying unit classifies the advertisements into a plurality of groups based on a condition related to history of behavior of the user.

8. The advertisement delivery apparatus according to claim 6, wherein the classifying unit classifies the advertisements into a plurality of groups based on a condition related to a user attribute of the user.

9. The advertisement delivery apparatus according to claim 1, wherein the classifying unit classifies the advertisements into a plurality of groups based on a condition related to a position at which each of the advertisements is displayed.

10. The advertisement delivery apparatus according to claim 1, wherein the classifying unit classifies the advertisements into a plurality of groups based on a condition related to a format of each of the advertisements.

11. The advertisement delivery apparatus according to claim 1, further comprising an acquiring unit that acquires the advertisements from an advertisement providing server by requesting the advertisements from the advertisement providing server for each of the groups.

12. The advertisement delivery apparatus according to claim 11, wherein the acquiring unit acquires the advertisements from the advertisement providing server by requesting an advertisement belonging to one of the groups from the advertisement providing server through auctioning, and acquires advertisements belonging to other groups using a scheme other than auctioning.

13. An advertisement delivery method executed by a computer, the advertisement delivery method comprising:
receiving a delivery request for a plurality of advertisements to be delivered to a terminal device;
classifying the advertisements for which the delivery request is received at the receiving into a plurality of groups based on a predetermined condition; and
determining the advertisements to be delivered, for each of the groups classified at the classifying.

14. A non-transitory computer readable storage medium having stored therein an advertisement delivery program causing a computer to execute:
receiving a delivery request for a plurality of advertisements to be delivered to a terminal device;
classifying the advertisements for which the delivery request is received at the receiving into a plurality of group based on a predetermined condition; and
determining the advertisements to be delivered, for each of the groups classified at the classifying.
